(19) United States
(12) Patent Application Publication
(10) Pub. No.: US 2020/0001998 A1
(43) Pub. Date: Jan. 2, 2020

(54) MOVABLE PLATFORM CONTROL METHOD AND MOVABLE PLATFORM

(71) Applicant: SZ DJI TECHNOLOGY CO., LTD., Shenzhen (CN)

(72) Inventors: Xiongbin RAO, Shenzhen (CN); Naibo WANG, Shenzhen (CN); Ming GONG, Shenzhen (CN); Xingsen LIN, Shenzhen (CN)

(21) Appl. No.: 16/569,798

(22) Filed: Sep. 13, 2019

Related U.S. Application Data
(63) Continuation of application No. PCT/CN2017/077513, filed on Mar. 21, 2017.

(51) Int. Cl. B64C 39/02; G05D 1/00; B64D 47/06; G01S 19/42; H04B 17/336; H04H 20/71

(52) U.S. Cl. CPC B64C 39/024; G05D 1/0011; B64D 47/06; B64C 2201/146; H04B 17/336; H04H 20/71; B64C 2201/027; G01S 19/42

(57) ABSTRACT

A method is provided for controlling a movable platform. The method includes determining whether the movable platform is capable of broadcasting information indicating a relevant parameter of the movable platform. The method also includes restricting a movement of the movable platform based on a determination that the movable platform is not capable of broadcasting the information.

### CROSS-REFERENCE TO RELATED APPLICATION

This application is a continuation application of International Application No. PCT/CN2017/077513, filed on Mar. 21, 2017, the entire content of which is incorporated herein by reference.

### TECHNICAL FIELD

The present disclosure relates to the technology field of movable platforms and, more particularly, to a movable platform control method and a movable platform.

### BACKGROUND

An unmanned aerial vehicle (“UAV”) is a type of a movable platform. The UAV is an aircraft that does not carry any human and is remotely controlled via radio frequency or controlled by software installed thereon. Because UAVs have advantages of low cost, high effectiveness-cost ratio, high flexibility, and high adaptability and safety stability, etc., they have received wide attention and become a hot topic in research.

As the price threshold has been lowered and operation flexibility has been increased, the appearance frequency of UAVs has become increasingly higher. In addition, operations who control the UAVs are no longer limited to professional players. However, as an aviation vehicle, while UAVs have brought new experience to the consumers, they also bring potential risks to the society due to the lack of proper management of UAVs in relative areas. Especially, when the UAVs are using the airspace, multiple issues exist, such as unclear flight region, privacy infringement, safety risks, etc. To ensure safety of the public, UAVs need a certain level of supervision.

Currently, the technologies used for supervising the UAVs primarily include listening and discovery, i.e., obtaining location information of a location of the UAV. The location information of a UAV may be obtained through phased array radar, electronic imaging, sound wave detection, and radio frequency signal detection, etc. Alternatively, the location information of the UAV may be obtained through an Automatic Dependent Surveillance-Broadcast (“ADS-B”) device communicating with a radar device on the ground. The UAV may be supervised by obtaining the location information through such technologies. However, such technologies have not provided an effective management mechanism while the UAV is flying in the air. Obtaining the location information of the UAV still cannot address the issues encountered during the flight, such as trespassing a secret national military base, jeopardizing the safety of passenger aircrafts, etc.

### SUMMARY

In accordance with an aspect of the present disclosure, there is provided a method for controlling a movable platform. The method includes determining whether the movable platform is capable of broadcasting information indicating a relevant parameter of the movable platform. The method also includes restricting a movement of the movable platform based on a determination that the movable platform is not capable of broadcasting the information

The technical solutions of the present disclosure have at least the following advantages:

Differing from the current technologies, the technical solutions of the present disclosure can effectively monitor a movable platform, such that when the movable platform cannot broadcast information of a relevant parameter, movement of the movable platform can be restricted. The technical solutions of the present disclosure can reduce the potential risk that may be brought by the movable platform when the supervision of the movable platform becomes ineffective, thereby realizing effective management of the movement of the movable platform, such as the flight of the UAV.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a schematic illustration of data transmission of a movable platform, according to an example embodiment.

FIG. 2 is a flow chart illustrating a method for controlling a movable platform, according to an example embodiment.

FIG. 3 is a schematic diagram of an assembly of a movable platform, according to an example embodiment.

FIG. 4 is a flow chart illustrating a method for controlling a movable platform, according to another example embodiment.

FIG. 5 is a flow chart illustrating a method for controlling a movable platform, according to another example embodiment.

FIG. 6 is a flow chart illustrating a method for controlling a movable platform, according to another example embodiment.

FIG. 7 is a schematic diagram of an assembly of a movable platform, according to another example embodiment.

FIG. 8 is a flow chart illustrating a method for controlling a movable platform, according to another example embodiment.

FIG. 9 is a flow chart illustrating a method for controlling a movable platform, according to another example embodiment.

FIG. 10 is a schematic illustration of location relationship between a supervision region and a flight restricted region, according to another example embodiment.

FIG. 11 is a flow chart illustrating a method for controlling a movable platform, according to another example embodiment.

FIG. 12 is a flow chart illustrating a method for controlling a movable platform, according to another example embodiment.

FIG. 13 is a flow chart illustrating a method for controlling a movable platform, according to another example embodiment.

FIG. 14 is a flow chart illustrating a method for controlling a movable platform, according to another example embodiment.

FIG. 15 is a flow chart illustrating a method for controlling a movable platform, according to another example embodiment.

FIG. 16 is a flow chart illustrating a method for controlling a movable platform, according to another example embodiment.

FIG. 17 is a schematic diagram of a movable platform, according to an example embodiment.

FIG. 18 is a schematic diagram of a movable platform, according to another example embodiment.

FIG. 19 is a schematic diagram of a movable platform, according to another example embodiment.

### DETAILED DESCRIPTION OF THE EMBODIMENTS

The present disclosure provides a movable platform control method and a movable platform. The present disclosure can realize supervision of the movable platform.

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

It should be understood that in the present disclosure, including the specification, claims, and the accompanying drawings, relational terms such as “first,” “second,” “third,” and “fourth,” etc. (if existing), are only used to distinguish an entity or operation from another entity or operation, and do not necessarily imply that there is an actual relationship or order between the entities or operations. It should be understood that data modified by such terms may be exchangeable under certain conditions, such that embodiments described herein may be implemented in manners or sequences other than those described herein or shown in the accompanying drawings. The terms “comprising,” “including,” or any other variations are intended to encompass non-exclusive inclusion, such that a process, a method, a system, a product, or a device having a plurality of listed items not only includes these items, but also includes other items that are not listed, or includes items inherent in the process, method, apparatus, or device.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for describing relative positional relationship.

In addition, the singular forms “a,” “an,” and “the” are intended to include the plural forms as well, unless the context indicates otherwise. The terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B. The term “module” as used herein includes hardware components or devices, such as circuit, housing, sensor, connector, etc. The term “communicatively couple(d)” or “communicatively connect(ed)” indicates that related items are coupled or connected through a communication channel, such as a wired or wireless communication channel. The term “unit,” “sub-unit,” or “module” may encompass a hardware component, a software component, or a combination thereof. For example, a “unit,” “sub-unit,” or “module” may include a processor, a portion of a processor, an algorithm, a portion of an algorithm, a circuit, a portion of a circuit, etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

It is understood that in various embodiments of the present disclosure, the movable platform may include any suitable device that may be movable. For example, the movable platform may include, but not be limited to, ground-based transportation vehicles, water-based transportation vehicles, aerial transportation vehicles, and other types of movable carrying vehicles. For illustrative purposes, a movable platform may include a passenger carrying vehicle and/or an unmanned aerial vehicle (“UAV”). Movement of a movable platform may include flight. However, without deviating from the concept covered by the contents of the present disclosure, wherever a UAV is described herein, the UAV may be replaced by another regular type of movable platform, and the flight of the UAV may be replaced by other types of movement related to the movable platform. The present disclosure does not limit the type of movable platform and the type of movement of the movable platform.

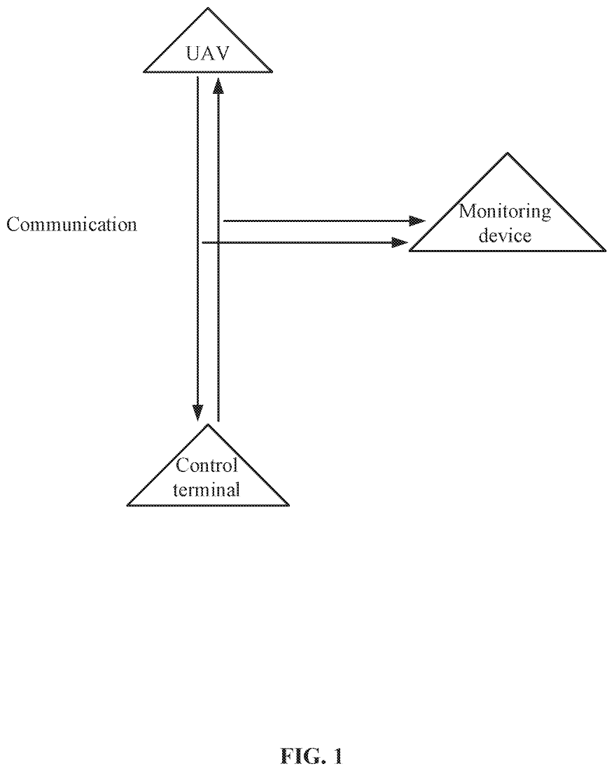

In some embodiments, assuming there is a UAV, as shown in FIG. 1. The UAV may be configured to communicatively connect with a control terminal such as a remote controller, such that the flight of the UAV may be controlled through the control terminal. In the meantime, data acquired by the UAV may be transmitted to the control terminal. In some embodiments, the UAV may be supervised by a supervision device. The supervision device may be configured to obtain communication data between the UAV and the control terminal.

In conventional technologies, a supervision device may be configured to obtain location information of a UAV through technologies, such as phased array radar, electronic imaging, sound wave detection, and radio frequency signal detection, so as to supervise the UAV. However, on one hand, acquired location information of the UAV is only the detailed location of the flight of the UAV. On the other hand, if the supervision device obtains ineffective location information of the UAV, it cannot realize the supervision of the UAV. However, under the two situations described above, the conventional technologies do not provide an effective management mechanism for effectively controlling the flight of the UAV.

In some embodiments, the present disclosure provides a movable platform control method and a movable platform, including a UAV. In general, the UAV may broadcast information of a relevant parameter of the UAV. However, when it is determined that the UAV cannot broadcast the information of the relevant parameter, the movement, i.e., flight, of the UAV may be restricted. Thus, when the supervision of the UAV becomes ineffective, the technical solutions of the present disclosure may restrict the flight of the UAV to reduce the potential risk that may be caused by the UAV, such as trespassing a secret national military base, jeopardizing the safety of passenger aircrafts, etc.

In some embodiments, a control terminal of a movable platform may include, but not be limited to, one or more of a remote controller, a smart cell phone, a tablet, a smart wearable device (e.g., a watch, a wristband), a ground-based control station, a personal computer (“PC”), and a laptop.

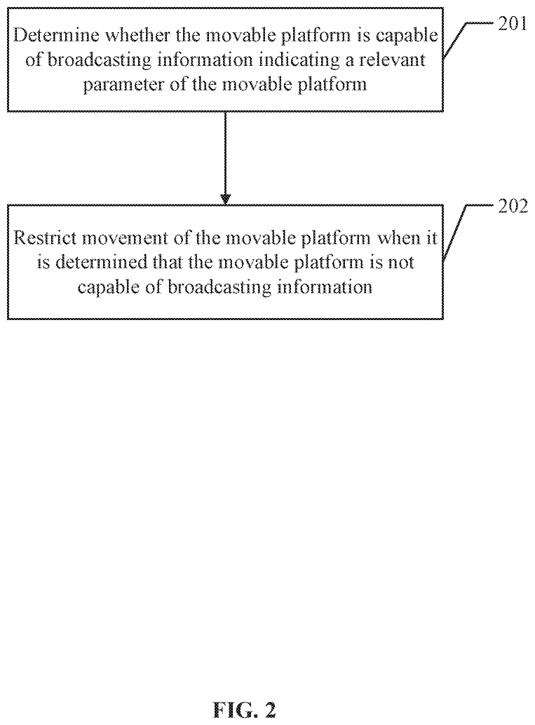

For the convenience of understanding, the detailed processes disclosed in the present disclosure will be described. Referring to FIG. 2, an embodiment of a method for controlling a movable platform may include:

Step 201: determining whether a movable platform is capable of broadcasting information indicating a relevant parameter of the movable platform;

In some embodiments, to realize operation safety of the movable platform, the movable platform may broadcast information indicating a relevant parameter while the movable platform is in operation, such that a supervision device of the movable platform or a control terminal may be aware of the whereabouts and model of the movable platform. In addition, the supervision device or control terminal may better control or manage the movable platform based on the information broadcasted by the movable platform.

In some embodiments, during the operation of the movable platform, the movable platform may detect (or examine), in real time, the capability of broadcasting information. A result of the detection may be used as a standard for determining whether supervision of the movable platform is effective. That is, when the movable platform is capable of broadcasting information indicating a relevant parameter of the movable platform, it may be determined that the supervision of the movable platform is effective. Conversely, it may be determined that the supervision of the movable platform is ineffective. As a result, different controls may be applied to the movable platform based on different results, which may reduce the risk that may be caused by the movable platform when the supervision of the movable platform is ineffective.

In some embodiments, the relevant parameter of the movable platform may include at least location information of the movable platform. The location information may include at least one of a longitude, a latitude, or an altitude.

In some embodiments, in actual applications, the relevant parameter may also include, but not be limited to, one or more of identification information, location information, movement parameters information, movement attitude information, owner information, purchase time information, purchase location information, historical movement path information, hardware configuration information, check bit information of the movable platform, and location information of the control terminal, which are not limited by the present disclosure.

Using the UAV as an example of the movable platform, the identification information of the movable platform may include, but not be limited to, identification symbol of the manufacturer and/or model of the UAV. Location information of the UAV may include, but not be limited to at least one of current location information of the UAV and location information of the UAV at takeoff. The movement parameter information may include, but not be limited to, at least one of a maximum flight velocity of the UAV, a maximum flight height of the UAV, and a current flight velocity. The movement attitude information may include, but not be limited to, at least one of a roll angle, a pitch angle, or a yaw angle of the UAV. The hardware configuration information may include, but not be limited to, configuration information of an effective load of the UAV. The check bit information may include, but not limited to, a cyclic redundancy check (“CRC”) bit, which may be used for checking information included in the supervision information other than the check bit information to improve the accuracy of the broadcasted information. The location information of the control terminal may include, but not be limited to, at least one of location information of the UAV at takeoff, or location information output by a positioning device of the control terminal.

In some embodiments, various methods may be used by the movable platform to broadcast information, such as Wi-Fi technology, software defined radio (“SDR”) technology, etc. Detailed technology used may be any suitable technology that is currently available, or any suitable technology that may be available in the future, as long as the technology can be used to broadcast information indicating the relevant parameter of the movable platform, which is not limited by the present disclosure.

Step 202: restricting movement of the movable platform when it is determined that the movable platform is not capable of broadcasting information.

In some embodiments, if it is determined that the movable platform is not capable of broadcasting information of the relevant parameter of the movable platform, the movement of the movable platform may be restricted.

In some embodiments, whether the movable platform is capable of broadcasting information indicating the relevant parameter of the movable platform can indicate whether the supervision of the movable platform is effective. Accordingly, when the movable platform is not capable of broadcasting information, one on hand, it is possible that hardware device issues of the movable platform may have caused the movable platform to be unable to broadcast the information indicating the relevant parameter of the movable platform, which hinders the realization of the supervision of the movable platform. On the other hand, it is possible that there is an error in the information indicating the relevant parameter of the movable platform. Even if such information is broadcasted, effective supervision of the movable platform still cannot be realized. As such, under the two situations described above, movement of the movable platform can be restricted to reduce as much as possible the risk that may be caused by the movable platform being out of supervision.

In some embodiments, if it is determined that the movable platform is capable of broadcasting information indicating the relevant parameter of the movable platform, then other operations may not be executed for the movable platform, such that the movable platform may maintain the current operations.

In some embodiments, by determining whether the movable platform is capable of broadcasting information indicating relevant parameter of the movable platform, whether the supervision of the movable platform is effective may be determined. Accordingly, when the movable platform is not capable of broadcasting information, movement of the movable platform may be restricted. Thus, when the supervision of the movable platform becomes ineffective, safety of the movable platform may be improved.

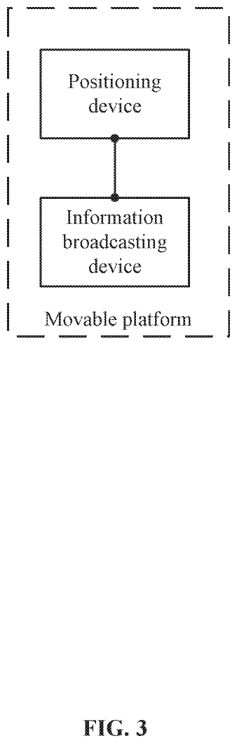

In some embodiments, in actual applications, as shown in FIG. 3, the movable platform may be provided with a positioning device. The positioning device may be configured to obtain parameters such as the current location information of the movable platform. In some embodiments, the movable platform may be provided with an information broadcasting device. The information broadcasting device may be configured to process information indicating the relevant parameter of the movable platform and broadcast the information. In some embodiments, the positioning device and the information broadcasting device may be communicatively connected to broadcast parameter information such as the location information of the movable platform. Then, whether the movable platform is capable of broadcasting information indicating the relevant parameter of the movable platform may be determined based on relevant judgment relating to the positioning device and the information broadcasting device, such as whether it is because there is a hardware device issue in the movable platform or whether it is because there is an error in the information indicating the relevant parameter of the movable platform. Next, the determination of whether the movable platform is capable of broadcasting information indicating the relevant parameter of the movable platform will be described in detail.

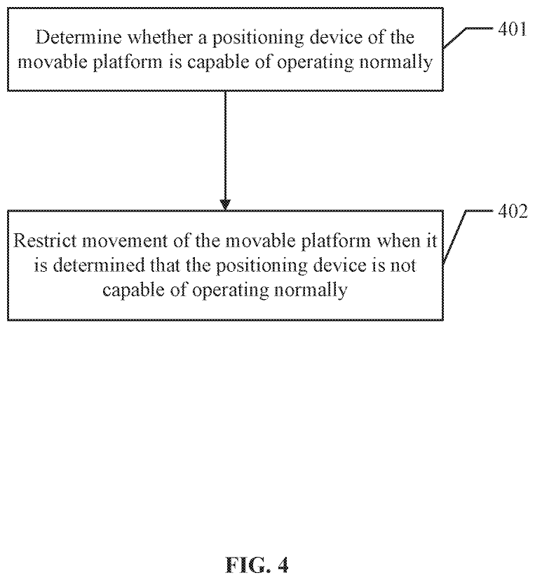

As shown in FIG. 4, another embodiment of a method for controlling a movable platform may include:

Step 401: determining whether a positioning device of the movable platform is capable of operating normally.

In some embodiments, the movable platform may be provided with a positioning device configured to obtain parameters such as current location information of the movable platform. When the movable platform broadcasts the information indicating the relevant parameter of the movable platform, the relevant parameter may include at least location information of the movable platform. Accordingly, whether the positioning device is capable of operating normally may indicate whether the location information of the movable platform can be obtained, i.e., whether the location information of the movable platform can be broadcasted. As such, by determining in real time whether the positioning device is capable of operating normally, whether the movable platform is capable of broadcasting information indicating the relevant parameter of the movable platform can be determined. If the positioning device is not capable of operating normally, it may be determined that the movable platform is not capable of broadcasting information.

In some embodiments, the positioning device may include a Global Navigation Satellite System (“GNSS”) device. The GNSS device may include a Global Positioning System (“GPS”) device. The positioning device may be configured to determine a location of the movable platform. In actual applications, the movable platform may determine whether the positioning device is capable of operating normally by detecting an operating status of the positioning device. For example, assuming that the positioning device includes a GPS device, the movable platform may detect whether the GPS device can receive a GPS signal. If the GPS device cannot receive the GPS signal, the movable platform may determine that the GPS device cannot operate normally.

It is understood that many factors may cause the movable platform to be unable to broadcast information. Therefore, it cannot be completely determined that the movable platform can broadcast information based on a normally-operating positioning device. A normally-operating positioning device only excludes one factor that may cause the movable platform to be unable to broadcast information.

In some embodiments, in actual applications, the positioning device, besides the GNSS device or the GPS device, may also be an inertial measurement unit (“IMU”), an ultrasonic sensor, a radar sensor, a vision sensor (e.g., a camera), or any combination thereof. The present disclosure does not limit the type of the positioning device.

Step 402: restricting movement of the movable platform when it is determined that the positioning device is not capable of operating normally.

In some embodiments, when it is determined that the positioning device of the movable platform is not capable of operating normally, the movement of the movable platform may be restricted.

In some embodiments, the method of restricting the movement of the movable platform may include one or more of:

restricting a height, a moving distance, an operation time, a moving velocity, a moving acceleration, or a moving direction of the movable platform.

In some embodiments, when it is determined that the positioning device is not capable of operating normally, it may be determined that the movable platform is not capable of broadcasting information indicating the relevant parameter of the movable platform. Then, during the current operations of the movable platform, one or more of a height, moving distance, operation time, moving velocity, moving acceleration, or moving direction of the movable platform may be restricted, to achieve the purpose of restricting the movement of the movable platform. In actual applications, the height, moving distance, operation time, moving velocity, and moving acceleration may be restricted within a corresponding predetermined value range. The moving direction of the movable platform may be restricted in a predetermined direction.

For example, when the movable platform is a UAV, as indicated in the “temporary regulation for management of system pilots of civil unmanned aerial vehicle systems,” for micro UAVs having a weight equaling to or smaller than 7 kilograms, a flight range should be within 500 meters visual line of sight, and lower than 120 meters relative height. Such micro UAVs do not need be managed by a license, but should avoid entering high altitude airspace. Therefore, when restricting the flight of the micro UAVs, the height of the micro UAVs should be lower than 120 meters.

In some embodiments, when it is determined that the positioning device is capable of operating normally, then other operations may not be executed for the movable platform, such that the movable platform may maintain the current operations. Because it cannot be completely determined whether the movable platform can broadcast information based on a normally-operating positioning device, other factors that may cause the movable platform to be unable to broadcast information may be detected and excluded, such that when the other factors cause the movable platform to be unable to broadcast information, movement of the movable platform may be restricted.

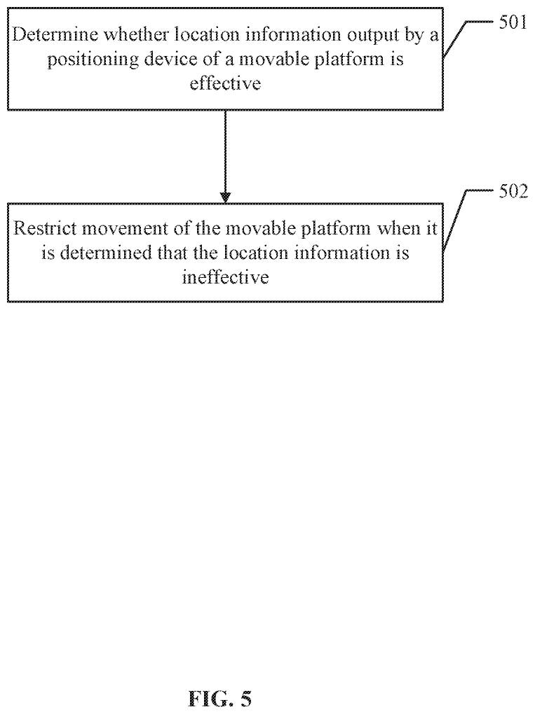

Referring to FIG. 5, another embodiment of a method for controlling a movable platform may include:

Step 501: determining whether location information output by a positioning device of a movable platform is effective.

In some embodiments, the movable platform may be provided with a positioning device configured to obtain parameters such as current location information of the movable platform. When the movable platform broadcasts the information indicating the relevant parameter of the movable platform, the relevant parameter may include at least location information of the movable platform. Accordingly, whether the location information output by the positioning device is effective may indicate whether the broadcasted information indicating the relevant parameter of the movable platform is effective. As such, by determining in real time whether the location information output by the positioning device of the movable platform is effective, whether the movable platform is capable of broadcasting information indicating the relevant parameter of the movable platform can be determined. That is, when the location information output by the positioning device is ineffective, it may be determined that the movable platform is not capable of broadcasting information.

In some embodiments, the method for determining the location information output by the positioning device of the movable platform is effective may include:

determining a signal-to-noise ratio of the location information. When the signal-to-noise ratio is smaller than or equal to a predetermined signal-to-noise ratio value, the location information may be determined to be ineffective; and/or

obtaining a number of satellites corresponding to the location information; when the number of satellites is smaller than or equal to a predetermined value, the location information may be determined to be ineffective.

In some embodiments, using a GPS device as an example of the positioning device, the determination of the effectiveness of the location information may be performed through two aspects: 1. The signal-to-noise ratio of the location information. The signal-to-noise ratio is a ratio between the signal and the noise. In the present disclosure, when the signal-to-noise ratio decreases, the signal of the satellite may be buried in the noise. This may indicate that the signal strength of the satellite is relatively weak, and is not suitable for measuring the location. The location calculated based on the satellite signal may be inaccurate, and the location information may be ineffective. Therefore, a predetermined signal-to-noise ratio value may be set as a standard for determining whether the location information is effective. When the signal-to-noise ratio is smaller than or equal to the predetermined signal-to-noise ratio value, the location information may be determined as ineffective. 2. The number of satellites corresponding to the location information. In actual applications, the GPS device and the satellites may establish communication channels, such as 16 channels. This means that the GPS device can establish communication with up to 16 satellites simultaneously. In theory, the GPS device can obtain correct positioning data through complex computation only after it receives signals from 3 or more satellites simultaneously. Conversely, the fewer the satellites, the less accurate the positioning data. Therefore, a predetermined value (for the number of satellites) may be set as a standard for determining whether the location information is effective. When the number of satellites is smaller than or equal to the predetermined value, it may be determined that the location information is ineffective.

It should be understood that the above two examples alone demonstrate the detailed method for determining whether the location information output by the positioning device of the movable platform is effective. In actual applications, other methods may be used independently or in combination. For example, a method may detect whether there is a change in the location attitude of the GPS device in the movable platform. The present disclosure does not limit such methods.

It is understood that many factors may cause the movable platform to be unable to broadcast information. Therefore, it cannot be completely determined that the movable platform can broadcast information based on a determination that the location information output by the positioning device is effective. Effective location information only excludes one factor that may cause the movable platform to be unable to broadcast information.

Some contents of the present embodiment may refer to some contents described in connection with step 401 in the embodiment shown in FIG. 4, which are not repeated.

Step 502: restricting movement of the movable platform when the location information is ineffective.

In some embodiments, when it is determined that the location information output by the positioning device of the movable platform is ineffective, the movement of the movable platform may be restricted.

In step 502, except for the prerequisite condition for restricting the movement of the movable platform, other contents may be similar to or the same as the contents described above in connection with step 402 in the embodiment shown in FIG. 4, which are not repeated.

It is noted that in the present embodiment, if the location information output by the positioning device of the movable platform is effective, then other operations may not be executed for the movable platform, such that the movable platform may maintain the current operations. However, because it cannot be completely determined that the movable platform can broadcast information based on the location information being effective, then the other factors that can cause the movable platform to be unable to broadcast information may be detected and excluded, such that when the other factors cause the movable platform to be unable to broadcast information, the movement of the movable platform may be restricted.

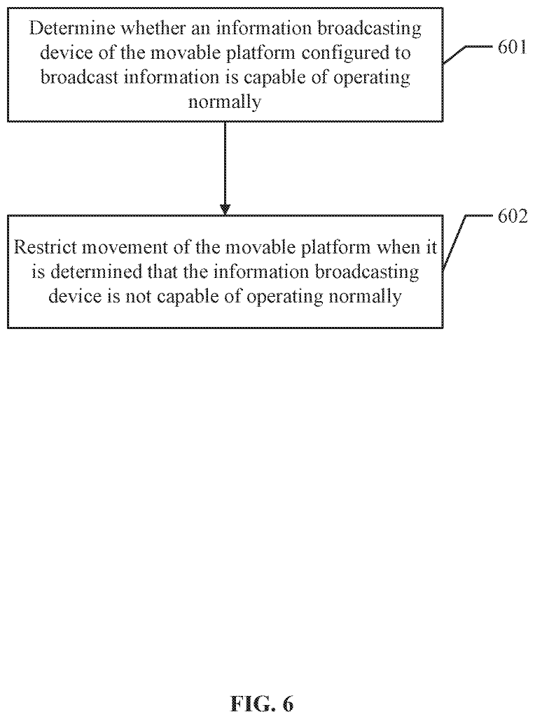

Referring to FIG. 6, another embodiment of a method for controlling a movable platform may include:

Step 601: determining whether an information broadcasting device of the movable platform configured to broadcast information is capable of operating normally.

In some embodiments, besides the positioning device, the movable platform may also be provided with an information broadcasting device. The information broadcasting device may be configured to process information indicating the relevant parameter of the movable platform, and broadcast the information. Then, by determining in real time whether the information broadcasting device of the movable platform can operate normally, it may be determined whether the movable platform can broadcast information indicating the relevant parameter of the movable platform. That is, when the information broadcasting device cannot operate normally, it may be determined that the movable platform cannot broadcast information.

In some embodiments, the method for determining whether the information broadcasting device of the movable platform is capable of operating normally may include:

determining whether a baseband processor of the information broadcasting device is capable of operating normally. When the baseband processor is not capable of operating normally, it may be determined that the information broadcasting device is not capable of operating normally; and/or

determining whether a transmitter configured to broadcast information in the information broadcasting device is capable of operating normally. When the transmitter is not capable of operating normally, it may be determined that the information broadcasting device is not capable of operating normally.

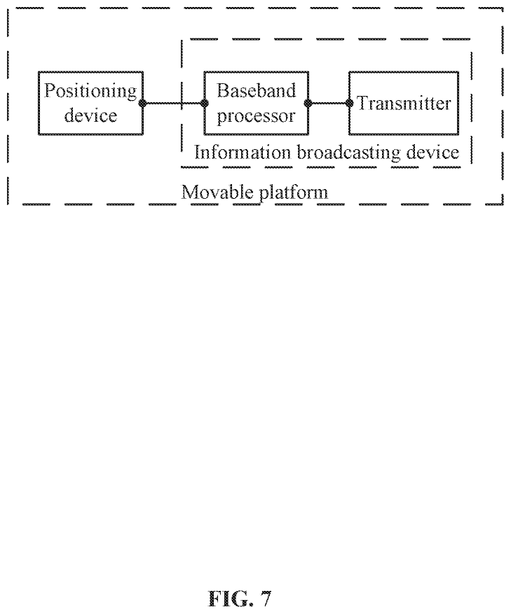

In some embodiments, on the basis of the contents described in connection with FIG. 3, in the present embodiment, as shown in FIG. 7, the information broadcasting device of the movable platform may include a baseband processor and a transmitter. The baseband processor may be communicatively connected with the transmitter. The baseband processor may be configured to process the information indicating the relevant parameter of the movable platform, such as computation, splitting, encoding, encryption, etc. The transmitter may be configured to transmit the processed information indicating the relevant parameter of the movable platform, i.e., to broadcast. In actual applications, it may be detected whether the baseband processor can process the information indicating the relevant parameter of the movable platform, such as computation, splitting, encoding, and encryption. If the baseband processor cannot process the information, it may be determined that the baseband processor cannot operate normally. In some embodiments, it may be detected whether the information indicating the relevant parameter of the movable platform has been transmitted successfully. If it has not been transmitted successfully, it may be determined that the transmitter cannot operate normally. As such, when either one or both of the baseband processor and the transmitter, i.e., the hardware devices of the information broadcasting device, cannot operate normally, it may be determined that the information broadcasting device cannot operate normally.

It should be understood that the above two examples alone demonstrate the detailed method for determining whether the information broadcasting device of the movable platform operates normally. In actual applications, other methods may be used independently or in combination. For example, a method may detect whether other components of the information broadcasting device operate normally, as long as the method can detect whether the information broadcasting device can operate normally. The present disclosure does not limit such methods.

It should be understood that because many factors can affect the inability of the movable platform to broadcast information, it cannot be completely determined that the movable platform can broadcast information based on a normally-operating information broadcasting device. A normally-operating information broadcasting device only excludes one factor that may cause the movable platform to be unable to broadcast information.

Step 602: restricting movement of the movable platform when it is determined that the information broadcasting device is not capable of operating normally.

In step 602, except for the prerequisite condition for restricting the movement of the movable platform, other contents of the step 602 may be similar to or the same as the contents described above in connection with step 402 shown in FIG. 4, which are not repeated.

In some embodiments, if it is determined that the information broadcasting device of the movable platform that is configured to broadcast the information can operate normally, then other operations may not be executed for the movable platform, such that the movable platform maintains the current operations. However, because it cannot be determined that the movable platform can broadcast information based on a normally-operating information broadcasting device, other factors that can cause the movable platform to be unable to broadcast information may be detected and excluded, such that when the other factors cause the movable platform to be unable to broadcast information, the movement of the movable platform may be restricted.

In some embodiments, combining the embodiments shown in FIG. 4, FIG. 5, and FIG. 6, at least two of the following may be determined: whether the positioning device can operate normally, whether the location information output by the positioning device is effective, and whether the information broadcasting device can operate normally. When any one of the following is determined: that the positioning device cannot operate normally, that the location information is ineffective, and that the information broadcasting device cannot operate normally, it may be determined that the movable platform cannot broadcast information indicating a relevant parameter of the movable platform. Based on this determination, movement of the movable platform may be restricted. In the meantime, if the factors that can cause the movable platform to be unable to broadcast information are only those three, then only when it is determined that the positioning device can operate normally, the location information is effective, and the information broadcasting device can operate normally, it can then be determined that the movable platform can broadcast information. It is understood that in actual applications, factors that may cause the movable platform to be unable to broadcast information may include other factors besides the above-described factors, as long as they may be used to determine whether the movable platform can broadcast information, which are not limited by the present disclosure.

In some embodiments, to ensure flight safety of the UAV, airspace traffic control in every country has different regulations for airspace near an airport or other region. Some countries may have flight restricted regions. For example, within a predetermined distance from an airport, regardless of the height or range of the UAV, all UAVs may be prohibited to fly. In actual applications, movable platforms may be UAVs. To ensure operation safety of the movable platforms, in some embodiments, flight restricted regions may be set. The flight restricted regions are regions that prohibit movement of the movable platform, such as national military secret base. In some embodiments, for the convenience of supervision of a movable platform, supervision regions may also be set. The supervision regions are regions in which the movable platform is supervised. Within a supervision region, information indicating a relevant parameter of the movable platform, which is broadcasted by the movable platform, may be obtained, such that a supervision device of the movable platform may obtain the relevant parameter of the movable platform in real time, to monitor the moving movable platform. Based on whether the supervision region is set or not, and the location relationship between the supervision region and the flight restricted region, restrictions on the movement of the movable platform are described below based on different situations.

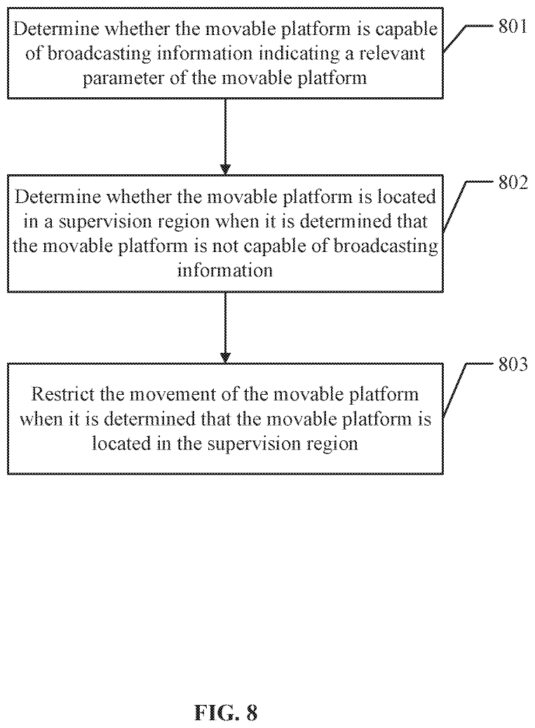

Referring to FIG. 8, another embodiment of a method for controlling a movable platform may include:

Step 801, which is the same as step 201 of the embodiment shown in FIG. 2. Hence, descriptions of step 810 are not repeated.

Step 802: determining whether the movable platform is located in a supervision region when it is determined that the movable platform is not capable of broadcasting information.

In some embodiments, when it is determined that the movable platform cannot broadcast information indicating a relevant parameter of the movable platform, it may be further determined whether the movable platform is in a supervision region.

In some embodiments, for the convenience of managing the safety of the movable platform, one or multiple supervision regions may be set. In a supervision region, the movable platform may be effectively managed by a supervision device and may be controlled by a control terminal of the movable platform. Location information of the one or multiple supervision regions may be stored in a storage device of the movable platform. In some embodiments, the location information may be determined from an external data source of the movable platform.

In some embodiments, the location of the supervision region may be any suitable region. The region may have any suitable shape, such as circle, square, triangle, natural or human defined shape, a shape corresponding to one or multiple area division rules, or a shape that is formed by any boundaries, etc. In some embodiments, the supervision region may include a space. The space may be a three-dimensional space having a latitude, a longitude, and an altitude.

In some embodiments, in actual applications, the supervision region, other than being the above-described region or three-dimensional space, can have any suitable number of dimensions, and measurement size of the dimensions, and/or can be specified by the locations of the dimensions, or a space, range, or line representing the region. The present disclosure does not limit the type of the supervision region.

In some embodiments, the location of the movable platform may be determined. The location of the supervision region may be obtained from the storage device of the movable platform or from an external data source. Through comparison, it may be determined whether the movable platform is located in the supervision region.

In some embodiments, the method for determining whether the movable platform is located in the supervision region, in addition to the above-described method, can adopt other suitable methods, such as a method that includes detecting whether the movable platform traverses regional boundaries of the supervision region. The present disclosure does not limit the method for determining whether the movable platform is located in a supervision region.

Step 803: restricting the movement of the movable platform when it is determined that the movable platform is located in the supervision region.

In step 803, except that the prerequisite conditions for restricting the movement of the movable platform are different, other contents are the same as the contents of step 402 of the embodiment shown in FIG. 4, which are not repeated.

In some embodiments, if it is determined that the movable platform can broadcast the information indicating a relevant parameter of the movable platform, other operations may not be executed for the movable platform, such that the movable platform may maintain the current operations.

In some embodiments, if it is determined that the movable platform cannot broadcast information indicating a relevant parameter of the movable platform, and the movable platform is not located in a supervision region, then it means that there is no need to restrict the movement of the movable platform. Other operations may not be executed for the movable platform, such that the movable platform can maintain the current operations.

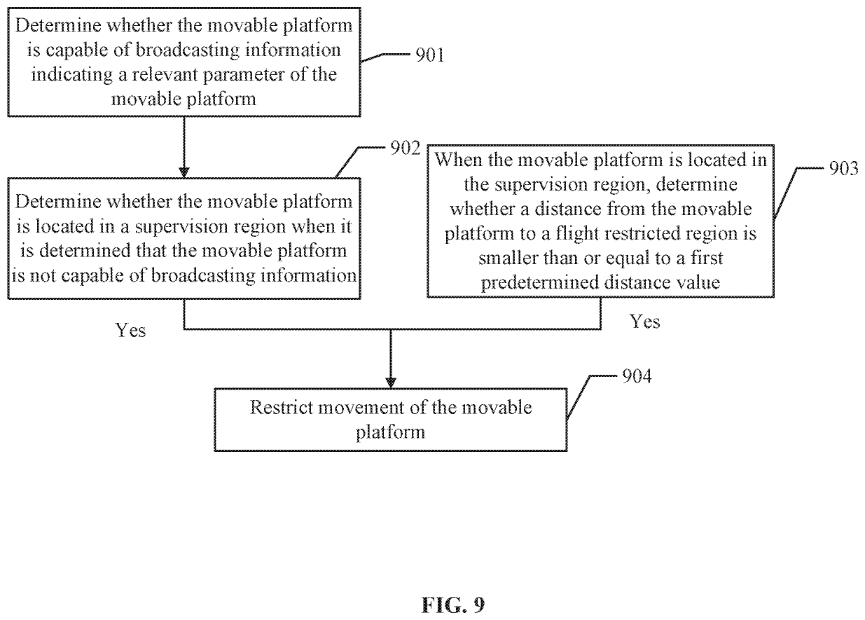

Referring to FIG. 9, another embodiment of a method for controlling a movable platform may include:

Step 901 and step 902, which are the same as steps 801 and 802, respective. Thus, the descriptions of steps 901 and 902 are not repeated.

Step 903: when the movable platform is located in the supervision region, determining whether a distance from the movable platform to a flight restricted region is smaller than or equal to a first predetermined distance value.

In some embodiments, when the movable platform is located in the supervision region, after determining the distance from the movable platform to the flight restricted region, it may be further determined whether the distance from the movable platform to the flight restricted region is smaller than or equal to the first predetermined distance value.

In some embodiments, one or multiple flight restricted regions may be set. Location information of the one or multiple flight restricted regions may be stored in a storage device of the movable platform. In some embodiments, the location information may be obtained from an external data source of the movable platform. Using an UAV as an example of the movable platform, an unauthorized UAV or all UAVs may not fly in the flight restricted region. The flight restricted region may include a no-navigation region. The no-navigation region may be an airspace region, including an airspace of a certain size defined by a region on a ground. The no-navigation region is often et for safety or other reasons related to a country. Sometimes, such flight restricted regions may be drawn on a navigation map or other publications. In some embodiments, the flight restricted region may include an airspace for special use. For example, a UAV may be restricted from entering a specified operational region, a forbidden airspace (e.g., a region that prohibits any aircraft from entering at any time, which may not be limited to authorizations from an airspace regulation entity), a military action region, a warning region, a vigilance region, a temporary flight restricted region, a national security region, and a shooting control region, etc. In some embodiments, the flight restricted region may be a permanent no-fly zone or a temporary region that prohibits flight. In actual applications, due to different management of the flight restricted region in different countries or due to other reasons, the flight restricted region may change overtime. As such, in the storage device or the external data source, the stored location of the flight restricted region may be updated in real time.

In some embodiments, the flight restricted region may be any suitable location. On one hand, the location may be a point (e.g., the latitude, longitude, and altitude of the point may be selectable). For example, the location of the flight restricted region may be a point at a center of an airport, or a point representing the airport or other type of flight restricted region. On the other hand, the location of the flight restricted region may be a region. The region may include any suitable shape, such as circle, square, triangle, natural or human defined shape, a shape corresponding to one or multiple area division rules, or a shape that is formed by any boundaries, etc. For example, the flight restricted region may be a boundary of an airport or other types of flight restricted region. In some embodiments, the supervision region may include a space. The space may be a three-dimensional space including a latitude, a longitude, and an altitude.

In some embodiments, in actual applications, the supervision region, other than being the above-described region or three-dimensional space, can have any suitable number of dimensions, and measurement size of the dimensions, and/or can be specified by the locations of the dimensions, or a space, range, line, or point representing the region. The present disclosure does not limit the type of the supervision region.

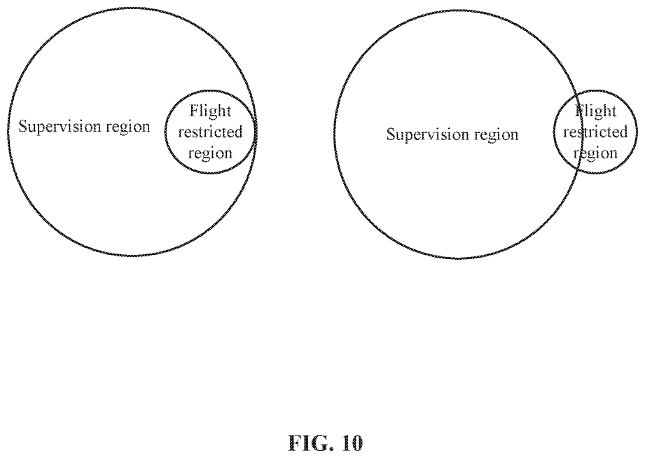

In some embodiments, in actual applications, for the convenience of managing the movable platform, the supervision region may at least partially include the flight restricted region. Examples of a supervision region and a flight restricted region are shown in FIG. 10. As shown in FIG. 10, assuming that the supervision region is a circular region, and the flight restricted region is another circular region, then there may be two location relationships between the supervision region and the flight restricted region: 1. The flight restricted region is included in the supervision region; 2. A portion of the flight restricted region overlaps with a portion of the supervision region. Based on the above location relationships, when it is determined that the movable platform cannot broadcast information and the movable platform is located in the supervision region, a distance between the movable platform and the flight restricted region may be determined. The detailed method for determining the distance may include:

Current location information of the movable platform may be determined through the positioning device of the movable platform or an external positioning device (e.g., pseudo-satellite, signal transmitting tower, or other structure that can provide location information). Location information of the flight restricted region may be obtained from the storage device of the movable platform or from an external data source. The current location information of the movable platform and the location information of the flight restricted region may be combined with other relevant movement parameters of the movable platform, such as the moving direction, to calculate a distance from the movable platform to a point in the flight restricted region. This distance may be determined as the distance from the movable platform to the flight restricted region. The distance from the movable platform to the flight restricted region may be the shortest distance from the movable platform to the flight restricted region, or may be a distance from the movable platform to the flight restricted region in the moving direction, or may be a distance from the movable platform to one or multiple specific points in the flight restricted region. Points in the flight restricted region for computing the distance may be determined based on the actual definition of the distance from the movable platform to the flight restricted region. The distance from the movable platform to the flight restricted region may be determined through any suitable computing method for calculating the distance between two points. For example, the distance from the movable platform to the flight restricted region may be calculated using an East North Up (“ENU”) coordinate system. Detailed calculation may refer to any currently available technologies, which are not repeated.

In some embodiments, the distance from the movable platform to the flight restricted region may be determined in real time, or periodically, such as every 5 minutes, every minute, every second, or every 0.1 second, or any other suitable period.

In some embodiments, a first predetermined distance value may be set based on the type of the movable platform and a moving capability of the movable platform. The first predetermined distance value may be different values, such as 1000 meters, 500 meters, 100 meters, 50 meters, 30 meters, 10 meters, etc. When the distance from the movable platform to the flight restricted region is smaller than or equal to the first predetermined distance value, the movement of the movable platform may be restricted to reduce, as much as possible, the safety issues caused by the movable platform entering the flight restricted region.

In some embodiments, beside the above described method, the method for determining the distance from the movable platform to the flight restricted region may adopt other suitable method, as long as the distance can be determined, which is not limited by the present disclosure. The distance from the movable platform to the flight restricted region may be one distance, or multiple distances, which may be determined based on actual needs. The present disclosure does not limit the distance.

In some embodiments, besides the above content, the location relationship between the supervision region and the flight restricted region may include other content in actual applications. For example, a supervision region may include multiple flight restricted regions. Multiple partial-regions of the supervision region may overlap with partial-regions corresponding to the multiple flight restricted region. The present disclosure does not limit the detailed location relationship.

Step 904: restricting movement of the movable platform.

In some embodiments, on one hand, when the movable platform cannot broadcast information and when the movable platform is located in a supervision region, movement of the movable platform may be restricted. On the other hand, when the movable platform is located in the supervision region and when the distance from the movable platform to the flight restricted region is smaller than or equal to the first predetermined distance value, movement of the movable platform may be restricted. Except that the prerequisite conditions for restricting the movement of the movable platform are different, other contents of step 904 are the same as the content of step 402 of the embodiment shown in FIG. 4, which are not repeated.

In some embodiments, step 903 may be executed prior to step 902. In some embodiments, steps 901 and 902 may be simultaneously executed. Step 903 and step 901 to step 902 are two conditions under which movement of movable platform needs to be restricted when the supervision region at least partially includes the flight restricted region: 1. When the movable platform cannot broadcast information and is located in a supervision region, the movement of the movable platform needs to be restricted; 2. When the movable platform is located in the supervision region, and when the distance from the movable platform to the flight restricted region is smaller than or equal to the first predetermined distance value, movement of the movable platform may be restricted, regardless of whether the movable platform can broadcast information. In actual applications, if the two conditions are both satisfied, the movement of the movable platform may also be restricted.

In some embodiments, if it is determined that the movable platform can broadcast information indicating a relevant parameter of the movable platform, then other operations may not be executed for the movable platform, such that the movable platform may maintain the current operations. When the movable platform is located in the supervision region, the distance between the movable platform and the flight restricted region may continue to be monitored, such that when the distance from the movable platform to the flight restricted region is smaller than or equal to the first predetermined distance value, movement of the movable platform may be restricted, which is not limited by the present disclosure.

In some embodiments, if it is determined that the movable platform cannot broadcast information indicating a relevant parameter of the movable platform, and the movable platform is not located in the supervision region, then it means that the movement of the movable platform does not need to be restricted. Then other operations may not be executed for the movable platform, such that the movable platform may maintain the current operations.

In some embodiments, if the movable platform is located in the supervision region, and the distance from the movable platform to the flight restricted region is greater than the predetermined distance value, it means that the movement of the movable platform does not need to be restricted. Other operations may not be executed for the movable platform, such that the movable platform may maintain the current operations. It may be further determined whether the movable platform can broadcast information, such that when the movable platform cannot broadcast the information, movement of the movable platform may be restricted, which is not limited by the present disclosure.

In some embodiments, in actual applications, based on the location relationship between the supervision region and the flight restricted region, if the movable platform is not located in the supervision region, the distance between the movable platform and the flight restricted region may still be monitored, such that when the distance between the movable platform and the flight restricted region is smaller than or equal to the first predetermined distance value, movement of the movable platform may be restricted, which is not limited by the present disclosure.

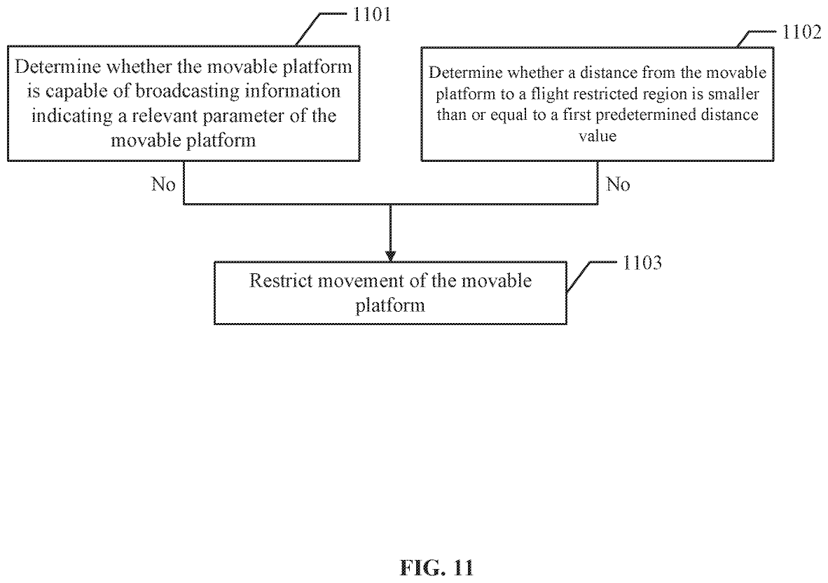

Referring to FIG. 11, another embodiment of a method for controlling a movable platform may include:

Step 1101, which is the same as step 201 of the embodiment shown in FIG. 2.

Descriptions of step 1101 can refer to those of step 201, which are not repeated.

Step 1102: determining whether a distance from the movable platform to a flight restricted region is smaller than or equal to a first predetermined distance value.

In some embodiments, the concept of a supervision region does not exist, and there is only one or more flight restricted regions. During a movement of the movable platform, after determining the distance from the movable platform to the flight restricted region, it may be determined whether the distance from the movable platform to the flight restricted region is smaller than or equal to the first predetermined distance value.

Some contents of step 1103 are the same as some contents of step 904 of the embodiment shown in FIG. 9, which are not repeated.

Step 1103: restricting movement of the movable platform.

In some embodiments, on one hand, when the movable platform cannot broadcast information, movement of the movable platform may be restricted. On the other hand, when the distance from the movable platform to the flight restricted region is smaller than or equal to the first predetermined distance value, movement of the movable platform may be restricted. In this embodiment, except that there is no supervision region, other contents are the same as the contents of step 904 of the embodiment shown in FIG. 9, which are not repeated.

In some embodiments, step 1102 may be executed prior to step 1101, or may be simultaneously executed with step 1101. Steps 1102 and 1102 represent two conditions under which the movement of the movable platform needs to be restricted when there is only one or more restricted regions: 1. When the movable platform cannot broadcast information, movement of the movable platform needs to be restricted; 2. When the distance from the movable platform and the flight restricted region is smaller than or equal to the first predetermined distance value, regardless of whether the movable platform can broadcast information normally, the movement of the movable platform needs to be restricted. In actual applications, if the two conditions are satisfied simultaneously, movement of the movable platform may also be restricted.

In some embodiments, if it is determined that the movable platform can broadcast information indicating a relevant parameter of the movable platform, then other operations may not be executed for the movable platform, such that the movable platform may maintain the current operations. The distance from the movable platform to the flight restricted region may continue to be monitored, such that when the distance from the movable platform to the flight restricted region is smaller than or equal to the first predetermined distance value, movement of the movable platform may be restricted, which is not limited by the present disclosure.

In some embodiments, if the distance from the movable platform to the flight restricted region is greater than the first predetermined distance value, then it means that the movement of the movable platform does not need to be restricted. Other operations may not be executed for the movable platform, such that the movable platform may maintain the current operations. It may continue to be determined whether the movable platform can broadcast information, such that when the movable platform cannot broadcast information, movement of the movable platform may be restricted, which is not limited by the present disclosure.

In some embodiments, in actual applications, when restricting the movement of the movable platform, a restriction strategy may be executed for the movable platform based on the current height, moving distance, and operation time of the movable platform. These will be described in detail below:

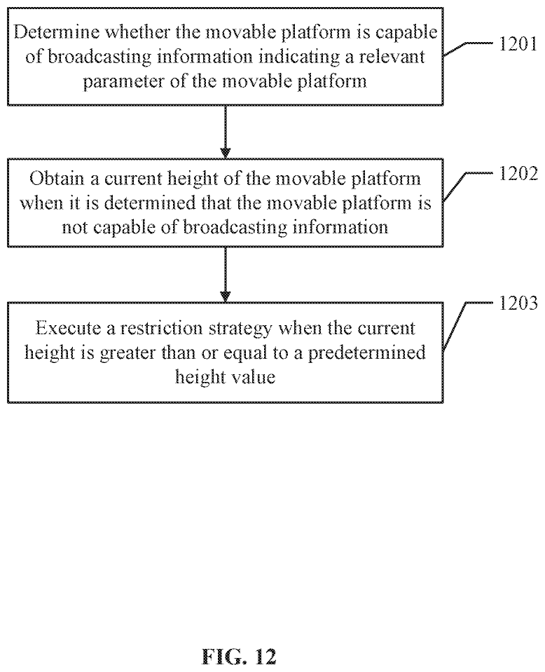

Referring to FIG. 12, another embodiment of a method for controlling a movable platform may include:

Step 1201, which is the same as step 201 of the embodiment shown in FIG. 2. Thus, descriptions of step 1201 may refer to those of step 201, which are not repeated.

Step 1202: obtaining a current height of the movable platform when it is determined that the movable platform is not capable of broadcasting information.

In some embodiments, when it is determined that the movable platform cannot broadcast information indicating a relevant parameter of the movable platform, a current height (e.g., altitude) of the movable platform may be obtained.

In some embodiments, the current height of the movable platform may be a perpendicular distance of the movable platform relative to an object. The current height may be used to determine whether to execute a restriction strategy on the movable platform. In actual applications, a barometer may be provided on the movable platform. Through a relationship between the air pressure and the heights, the current height of the movable platform may be determined based on a current air pressure value measured by the barometer. In some embodiments, the current location information of the movable platform may also be obtained through a positioning device of the movable platform or through an external positioning device. The current location information may include a current longitude, latitude, and altitude of the movable platform. The current height of the movable platform may be determined based on the current location information.

In some embodiments, assuming the positioning device may be one of an ultrasound sensor, a radar sensor, or a camera, then the bottom of the movable platform may be mounted with an ultrasound sensor. The ultrasound sensor may face an object and face downwardly, and may be configured to transmit an ultrasound signal and receive a reflected signal of the ultrasound signal. The current height of the movable platform may be determined based on a transmitting time of the ultrasound signal, a receiving time of the reflected signal of the ultrasound signal, and a transmitting speed of the ultrasound signal. In some embodiments, the bottom of the movable platform may be mounted with a camera. The camera may be a monocular camera or a binocular camera. The camera may face the object and face downwardly. When determining a focusing location of the object through the camera, a focal length of the camera may be obtained. An object distance corresponding to the current focal length may be determined based on a stored relationship between focal lengths and the object distances. The determined object distance is the distance between the camera and the object. The current height of the movable platform may be calculated based on a location relationship between the camera and the movable platform and a height of the camera. In some embodiments, the bottom of the movable platform may be provided with a radar sensor. The radar sensor may face the object and face downwardly, and may transmit radar signals and receive reflected signals of the radar signals. The current height of the movable platform may be determined based on a transmitting time of the radar signal, a receiving time of the reflected signal of the radar signal, and a transmitting velocity of the radar signal.

In the present embodiment, the above examples demonstrate the detailed method for obtaining the current height of the movable platform. In actual applications, other methods may be adopted. For example, short-distance distance measurement sensors, such as time of flight (“TOF”) sensors may be added to the movable platform to measure distance. As another example, light detection and ranging (“Lidar”) sensors and/or infrared sensors may be used, which may use a flight time of a light impulse wave to measure distance. The present disclosure does not limit the type of distance measurement sensors, as long as the current height of the movable platform can be measured.

In some embodiments, the object may be an obstacle, such as a building, a carton box on the ground, or the ground. The present disclosure does not limit the type of the object, as long as there is a vertical height difference between the movable platform and the object.

Step 1203: executing a restriction strategy when the current height is greater than or equal to a predetermined height value.

In some embodiments, when the movable platform cannot broadcast information, movement of the movable platform may need to be restricted. Restricting the movement of the movable platform may include restricting one or more of a height, a moving distance, an operation time, a moving velocity, a moving acceleration, or a moving direction of the movable platform. In actual applications, the predetermined height value may be set to be, for example, 50 meters, 100 meters, 150 meters, etc., which may serve as a standard for determining whether to execute the restriction strategy for the movable platform. For different geographical locations, the predetermined height value may be different. For example, at some locations with certain latitudes and longitudes, flight restriction may apply to all heights. At other locations with certain latitudes and longitudes, flight restriction may only apply to certain heights, and may not apply to other heights.

In some embodiments, when it is determined that the current height of the movable platform is greater than or equal to the predetermined height value, the restriction strategy may be executed for the movable platform:

1. Controlling the movable platform to stay at the current location;

In some embodiments, when the current height of the movable platform is greater than or equal to the predetermined height value, the movable platform may be controlled to stay at the current location, i.e., the movable platform may be controlled to remain the current height unchanged, the moving distance unchanged, such that the movable platform hovers at the current location.

For example, assuming that flight restriction applies to heights above 300 meters at locations with certain latitudes and longitudes, and the predetermined height value is 250 meters, then when it is determined that the movable platform cannot broadcast information, if it is further determined that the current height of the movable platform is 260 meters, exceeding the predetermined height value, then the movable platform may be controlled to hover at the height of 260 meters, to avoid the movable platform entering spaces of over 300 meters high to operate.

2. Controlling the movable platform to move to a predetermined region.

In some embodiments, when the current height of the movable platform is greater than or equal to the predetermined height value, the movable platform may be controlled to move to a predetermined region. In the predetermined region, the height, moving distance, moving velocity, moving acceleration, and moving direction of the movable platform may be restricted. The predetermined region may include, but not be limited to, a legal operation region of the movable platform.

For example, assuming that at certain regions with certain latitudes and longitudes, flight restriction applies to height of over 300 meters, and the predetermined height value is 250 meters, then when it is determined that the movable platform cannot broadcast information, and it is further determined that the current height of the movable platform is 260 meters, exceeding the predetermined height value, the movable platform may be controlled to move to a height below 250 meters, or to move to other regions of other latitudes and longitudes while at the meantime the height of the movable platform is controlled to be lower than the predetermined height value of the location having the current latitude and longitude, or to move to a legal operation region having no height restrictions.

3. Controlling the movable platform to move to a predetermined location.

In some embodiments, when the current height of the movable platform is greater than or equal to the predetermined height value, the movable platform may be controlled to move to the predetermined location. The predetermined location may include at least one of a location where the movable platform initially starts to move, or a location where the control terminal of the movable platform is located. In some embodiments, when the location where the movable platform initially starts to move and the location where the control terminal of the movable platform is located are relatively close to one another, the location where the control terminal is located may be approximated as the location where the movable platform initially starts to move. During the process of moving the movable platform to the predetermined location, the height, moving distance, operation time, moving velocity, moving acceleration, and moving direction of the movable platform may be restricted at different degrees.

In some embodiments, when the current height of the movable platform is greater than or equal to the predetermined height value, the movable platform may transmit restriction information to the control terminal of the movable platform. The restriction information may be configured to indicate that the movable platform is executing the restriction strategy, such that the control terminal of the movable platform may provide a prompt to a user through a mobile application, a flight status indicator, an audio indicator, or other indicators. Method for providing the prompt may include, but not be limited to, a text prompt, an audio prompt, a multi-media prompt, an image prompt, etc.

In some embodiments, when the movable platform executes the restriction strategy, one or multiple indicator lamps may be turned on or flashed based on a predetermined control scheme, such that the movable platform may further provide a prompt from a vision sense perspective to indicate the action of executing the restriction strategy. As such, when the movable platform cannot broadcast information and the current height is smaller than the predetermined height value, the user may increase the supervision of the movable platform.

In some embodiments, in actual applications, when the movable platform executes the restriction strategy, in addition to starting one or multiple indicator lamps, the movable platform may use other methods independently or in combination to provide the corresponding prompt, such as providing a predetermined sound through an audio device, which are not limited by the present disclosure.

In some embodiments, if it is determined that the movable platform can broadcast information indicating a relevant parameter of the movable platform, when other operations may not be executed for the movable platform, such that the movable platform may maintain the current operations. The distance from the movable platform to the flight restricted region may continue to be monitored, and the present disclosure does not limit this.

In some embodiments, if it is determined that the movable platform cannot broadcast information indicating a relevant parameter of the movable platform, and it is determined that the current height of the movable platform is smaller than the predetermined height value, restriction strategy may not be executed for the movable platform, or may be executed for the movable platform, which is not limited by the present disclosure.

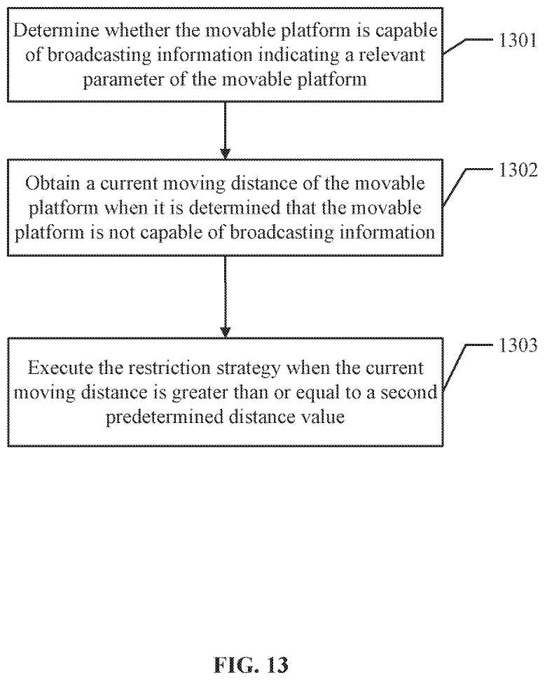

Referring to FIG. 13, another embodiment of a method for controlling a movable platform may include:

Step 1301, which is the same as step 201 of the embodiment shown in FIG. 2.

Therefore, contents of step 1301 are not repeated.

Step 1302: obtaining a current moving distance of the movable platform when it is determined that the movable platform is not capable of broadcasting information.

In some embodiments, when it is determined that the movable platform cannot broadcast information, the current moving distance of the movable platform may be obtained.

In some embodiments, because the movable platform may be communicatively connected with the control terminal of the movable platform, and be supervised by a supervision device, and may start moving from different locations, the current moving distance of the movable platform has multiple meanings. In the present embodiment, the current moving distance of the movable platform may be a distance from the movable platform to a moving-start point, or a distance from the movable platform to the control terminal of the movable platform. In some embodiments, when the moving-start point of the movable platform is relatively close to the control terminal of the movable platform, the location of the control terminal may be approximated as the moving-start point of the movable platform.

In some embodiments, the current moving distance of the movable platform may be determined based on one or more of location information output by a positioning device of the movable platform, a power of a signal the movable platform received from the control terminal of the movable platform, a round-trip time of a signal between the movable platform and the control terminal of the movable platform. For example, when the current moving distance is a distance from the movable platform to the control terminal of the movable platform, the detailed method for determining the moving distance may include:

1. Assuming the positioning device is a GPS device, the movable platform may obtain current location information of the movable platform from the GPS device, or obtain location information of the control terminal of the movable platform from a storage device or an external data source, thereby determining a horizontal distance d and a height difference h between the current location of the movable platform and the control terminal. Further, the current moving distance D of the movable platform may be calculated based on the following equation:

D=\sqrt{d²+h²}

2. The movable platform establishes a communication connection with the control terminal of the movable platform. The communication may be established through a local area network (“LAN”), a wide area network (“WAN”), or any other suitable communication technology. The communication between the movable platform and the control terminal of the movable platform may be two-way communication and/or one-way communication. For example, the control terminal of the movable platform may provide commands to the movable platform to control the movement or other functions of the movable platform. The movable platform may provide information indicating a relevant parameter of the movable platform or other sensing data to the control terminal of the movable platform. The communication may transmit, simultaneously or in sequence, commands from the control terminal of the movable platform and/or data from the movable platform. In actual applications, data may be transmitted between the movable platform and the control terminal of the movable platform through the same communication channel or different communication channels.

In some embodiments, the movable platform may calculate the current moving distance D of the movable platform based on the power of the signal received from the control terminal of the movable platform and an attenuation relationship of the receiving power and distances in a free space, as shown in the following equation:

$$D = {10}^{\frac{{P}_{tx} + {h}_{txrx} - 32.5 - 20 {log}_{10} f - {P}_{rsrp} + X}{20}}$$

In the above equation, Pₜₓ represents the transmitting power of a transmitter of an information broadcasting device of the movable platform, hₜₓᵣₓ represents a gain of an antenna, f represents a carrier frequency, Pᵣₛₚ represents a receiving power of the control terminal, X represents the shadow attenuation of the link attenuation. When the movable platform is a UAV, the value of X for the communication may be 10 dB, for example.

3. After the movable platform establishes a communication connection with the control terminal of the movable platform, during a communication between the movable platform and the control terminal of the movable platform, the current moving distance D of the movable platform may be calculated based on a round-trip time (“RTT”) of a signal between the movable platform and the control terminal of the movable platform in the following equation:

D=c*RTT/2

In this equation, c represents the speed of light.

In some embodiments, in actual applications, among the above three methods for calculating the current moving distance of the movable platform, any one of the three methods may be used to calculate the current moving distance. In some embodiments, any two or three of the methods may be used to calculate two or three moving distances, which may be weighted to arrive at a weighted value. The weighted value may be used as the current moving distance of the movable platform. The present disclosure does not limit the method for calculating the current distance of the movable platform.

In some embodiments, in actual applications, besides the above contents, the detailed methods for determining the current moving distance of the movable platform may use other methods independently or in combination, as long as the current moving distance of the movable platform can be determined. The present disclosure does not limit the methods for determining the current moving distance of the movable platform.

Step 1303: executing the restriction strategy when the current moving distance is greater than or equal to a second predetermined distance value.

In some embodiments, when the movable platform cannot broadcast information and the current moving distance of the movable platform is greater than or equal to the second predetermined distance value, the restriction strategy may be executed.

In some embodiments, the second predetermined distance value may be set as 1000 meters, 500 meters, 300 meters, or other suitable value, which may be a standard for determining whether to execute the restriction strategy for the movable platform. Different second predetermined distance values may be set for different definitions of the current moving distances of the movable platform, which are not limited by the present disclosure.

Step 1303 of the present embodiment, except that the prerequisite condition for executing the restriction strategy is different, other contents are the same as step 1303 of the embodiment shown in FIG. 12, which are not repeated.

In some embodiments, if it is determined that the movable platform can broadcast information indicating a relevant parameter of the movable platform, then other operations may not be executed for the movable platform, such that the movable platform may maintain the current operations. The distance from the movable platform to the flight restricted region may continue to be monitored, such that when the distance from the movable platform to the flight restricted region is smaller than or equal to the first predetermined distance value, movement of the movable platform may be restricted, which is not limited by the present disclosure.

In some embodiments, if it is determined that the movable platform cannot broadcast information indicating a relevant parameter of the movable platform, and it is determined that the current moving distance of the movable platform is smaller than the second predetermined distance value, then restriction strategy may not be executed for the movable platform, or may be executed for the movable platform, which is not limited by the present disclosure.

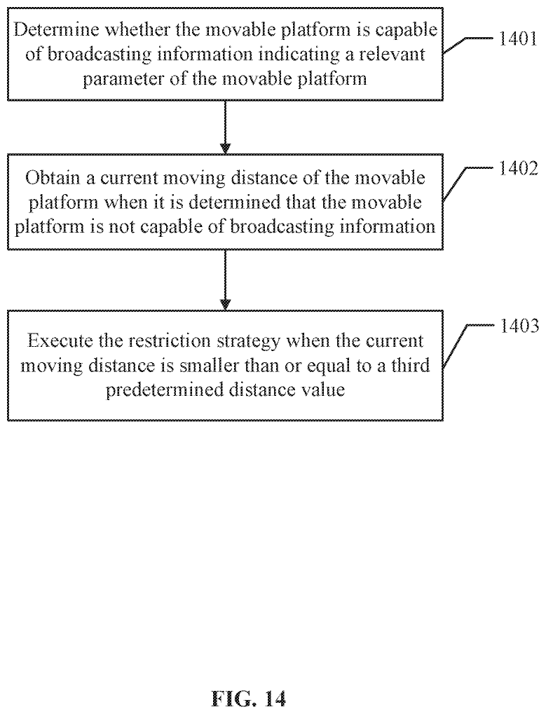

Referring to FIG. 14, another embodiment of a method for controlling the movable platform may include:

Step 1401, which is the same as step 201 of the embodiment shown in FIG. 2. Hence, contents of step 1401 are not repeated.

Step 1402: obtaining a current moving distance of the movable platform when it is determined that the movable platform is not capable of broadcasting information.

In some embodiments, when it is determined that the movable platform cannot broadcast information, the current moving distance of the movable platform may be obtained.

Bases on partial contents described above for step 1302 of the embodiment shown in FIG. 13, on one hand, in the present embodiment, the current moving distance of the movable platform may include a distance from the movable platform to a supervision device of the movable platform. In some embodiments, during the communication between the movable platform and the control terminal of the movable platform, the supervision device may obtain, in the communication channel, information indicating a relevant parameter of the movable platform. In actual applications, the supervision device may be provided at any suitable location. When the supervision device is provided at a boundary of the flight restricted region or at a point in the flight restricted region, to avoid the movable platform entering the flight restricted region, a current distance between the movable platform and the supervision device may be obtained. The current distance may be compared with a limit on the distance between the movable platform and the flight restricted region. When the movable platform is relatively close to the supervision device, the restriction strategy may be executed for the movable platform. In some embodiments, the current moving distance of the movable platform may be determined based on one or more of a power of a signal transmitted by the supervision device and received by the movable platform, or a round-trip time of a signal between the movable platform and the supervision device. The detailed calculation method may refer to the descriptions of step 1302 of the embodiment shown in FIG. 13, which is not repeated.

On the other hand, the current moving distance of the movable platform may include a distance from the movable platform to the flight restricted region. By defining the current moving distance of the movable platform to be the distance from the movable platform to the flight restricted region, the movable platform may be monitored in real time, and may be prevented from entering the flight restricted region. In some embodiments, the boundary of the flight restricted region may include an electronic label. The current moving distance of the movable platform may be determined based on one or more of a power of a signal transmitted by the electronic label and received by the movable platform, or a round-trip time of a signal between the movable platform and the electronic label. The detailed method may refer to the contents described above for step 1302 of the embodiment shown in FIG. 13, which is not repeated.

Step 1403: executing the restriction strategy when the current moving distance is smaller than or equal to a third predetermined distance value.

In some embodiments, when the movable platform cannot broadcast information and when the current moving distance of the movable platform is smaller than or equal to the third predetermined distance value, the restriction strategy may be executed.

In some embodiments, the third predetermined distance value may be set as 1000 meters, 500 meters, 100 meters, 50 meters, 30 meters, 10 meters, etc., and may serve as a standard for determining whether to execute the restriction strategy for the movable platform. Different third predetermined distance values may be set for different definitions of the current moving distance of the movable platform, which are not limited by the present disclosure.

In step 1403, except that the prerequisite condition for executing the restriction strategy is different, other contents of step 1403 are the same as the contents of step 1203 of the embodiment shown in FIG. 12, which are not repeated.

In some embodiments, if it is determined that the movable platform can broadcast information indicating a relevant parameter of the movable platform, when other operations may not be executed for the movable platform, such that the movable platform may maintain the current operations. The distance from the movable platform to the flight restricted region may continue to be monitored, such that when the distance from the movable platform to the flight restricted region is smaller than or equal to the first predetermined distance value, movement of the movable platform may be restricted, which is not limited by the present disclosure.

In some embodiments, if it is determined that the movable platform cannot broadcast information indicating a relevant parameter of the movable platform, and the current moving distance of the movable platform is greater than the third predetermined distance value, then the restriction strategy may not be executed for the movable platform, or may be executed for the movable platform, which is not limited by the present disclosure.

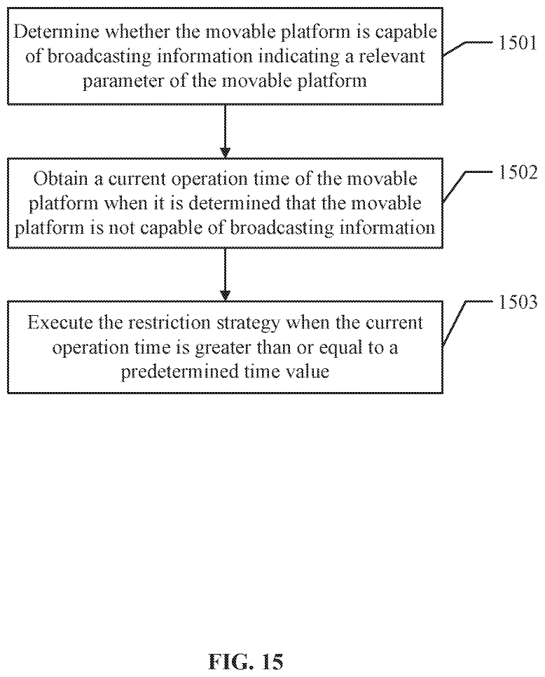

Referring to FIG. 15, another embodiment of a method for controlling the movable platform may include:

Step 1501, which is the same as step 201 of the embodiment shown in FIG. 2. Hence, the contents of step 1501 are not repeated.

Step 1502: obtaining a current operation time of the movable platform when it is determined that the movable platform is not capable of broadcasting information.

In some embodiments, when it is determined that the movable platform cannot broadcast information, a current operation time of the movable platform may be obtained.

On one hand, the continuous flight capability of the movable platform is limited, and the number of base stations provided on the ground for servicing the movable platform to provide power is limited. During the movement of the movable platform, when it is determined that the movable platform cannot broadcast information, the current operation time of the movable platform may be obtained, such that when the supervision device cannot obtain information indicating the relevant parameter of the movable platform, the operation time of the movable platform may be effectively controlled. As a result, when the continuous flight capability of the movable platform is exhausted, by obtaining the current operation time of the movable platform, the operation of the movable platform may be controlled based on the current operation time until the base stations provide power to the movable platform to renew the continuous flight capability. As such, the safety of the movable platform can be maintained.

On the other hand, when the movable platform cannot broadcast information, it means the supervision device cannot realize effective supervision for the movable platform. Then, to avoid the situation of the movable platform losing the effective supervision, through obtaining the current operation time of the movable platform, it may be determined whether the movable platform may enter the flight restricted region to cause occurrence of danger.

In some embodiments, the current operation time of the movable platform may include, but not be limited to, one or more of an operation time of a propulsion system of the movable platform, a power supply time of the movable platform, or a time during which the movable platform is in a moving state. Whether various components of the propulsion system of the movable platform match with one another, whether the propulsion system matches with the entire machine, may directly affect the efficiency and stability of the entire machine. Hence, the propulsion system is important to the movable platform. In general, the propulsion system of the movable platform is primarily based on electric motors, and may include an electric motor, an electric speed control (for controlling the rotation speed of the electric motor), a propeller, and a battery. In current operations, the movable platform may retrieve the time at which the propeller starts to rotate, and may combine that with the current time to determine the operation time of the propulsion system of the movable platform. A battery may be provided in the propulsion system of the movable platform. The operation time of the battery may determine the continuous flight capability of the movable platform. The movable platform may determine the power supply time of the movable platform through obtaining the remaining electric charge or the consumed electric charge. Because when the movable platform is in a moving state, the electric motor operates continuously, then the time during which the movable platform is in a moving state may be determined through a time during which the electric motor of the movable platform operates.

It is understood that the methods for determining the operation time of the propulsion system of the movable platform, the power supply time of the movable platform, and the time during which the movable platform is in a moving state are only illustrative examples. In actual applications, other methods may be adopted. For example, such times may be determined through an operation time of a velocity sensor. The present disclosure does not limit how the times are determined.

Step 1503: executing the restriction strategy when the current operation time is greater than or equal to a predetermined time value.

In some embodiments, when the movable platform cannot broadcast information and the current operation time of the movable platform is greater than or equal to the predetermined time value, the restriction strategy may be executed, such that the operation time of the movable platform may be effectively controlled to avoid occurrence of potential risk of the movable platform.

In some embodiments, the predetermined time value may be set as 4 hours, 3 hours, 2 hours, 1 hour, etc., to serve as a standard for determining whether to execute the restriction strategy for the movable platform. For different definitions of current operation time of the movable platform, there may be different predetermined time values, which are not limited by the present disclosure.

In some embodiments, when the current operation time of the movable platform includes multiple times, as long as one of the times is greater than or equal to the predetermined time value, the restriction strategy may be executed.

In step 1503, except that the prerequisite conditions for executing the restriction strategy are different, other contents are the same as the contents of step 1203 of the embodiment shown in FIG. 12, which are not repeated.

In some embodiments, if it is determined that the movable platform cannot broadcast information indicating a relevant parameter of the movable platform, then other operations may not be executed for the movable platform, such that the movable platform may maintain the current operations. The distance from the movable platform to the flight restricted region may continue to be monitored, such that when the distance from the movable platform to the flight restricted region is smaller than or equal to the first predetermined distance value, the movement of the movable platform may be restricted, which is not limited by the present disclosure.

In some embodiments, if it is determined that the movable platform cannot broadcast information indicating the relevant parameter of the movable platform, and it is determined that the current operation time of the movable platform is smaller than a predetermined time value, then the restriction strategy may not be executed for the movable platform, or may be executed for the movable platform, which is not limited by the present disclosure.

In some embodiments, in actual applications, when executing the restriction strategy, the movable platform may automatically execute it, or the movable platform may be controlled by a supervision device to execute it. Next, one situation is used as an example to explain how the movable platform execute the restriction strategy:

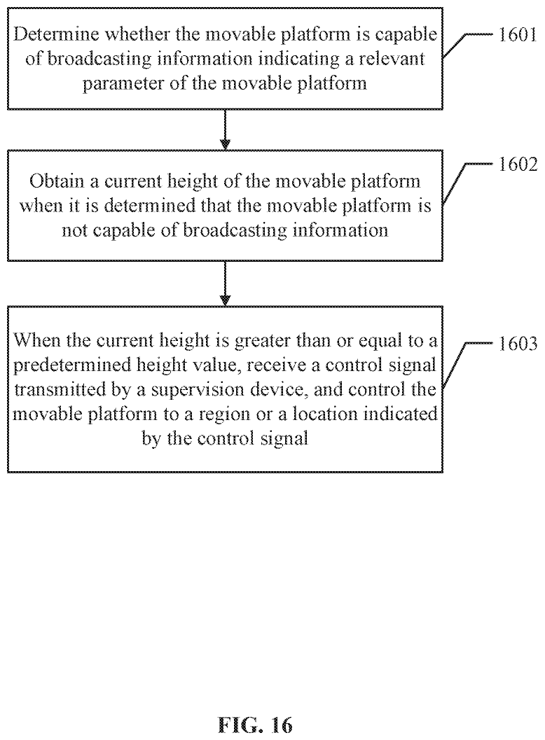

Referring to FIG. 16, another embodiment of a method for controlling the movable platform may include:

Steps 1601-1602 are the same as steps 1201-1202 of the embodiment shown in FIG. 12, which are not repeated.

Step 1603: when the current height is greater than or equal to a predetermined height value, receiving a control signal transmitted by a supervision device, and controlling the movable platform to a region or a location indicated by the control signal.

In some embodiments, when the movable platform cannot broadcast information and when the current height of the movable platform is greater than or equal to the predetermined height value, the movable platform may receive the control signal transmitted by the supervision device, and may control, based on the control signal, the movable platform to a region or location indicated by the control signal.

In some embodiments, when the movable platform cannot broadcast information, the supervision device may not obtain information indicating a relevant parameter of the movable platform, or the information obtained cannot correctly indicate the relevant parameter of the movable platform. Then, the supervision device may deem, by default, that the supervision of the movable platform is ineffective. To maintain the safety of the movable platform, a control signal may be transmitted to the movable platform. When the movable platform receives the control signal, the movable platform may control its movement based on the control signal, and may move to a region or location indicated by the control signal.

In some embodiments, the region indicated by the control signal may be a predetermined region. The predetermined region may include a legal operation region of the movable platform. The location indicated by the control signal may be a predetermined location. The predetermined location may be the current location of the movable platform, or a moving-start location of the movable platform, or a location at which the control terminal of the movable platform is located, which is not limited by the present disclosure.

In some embodiments, detailed method of controlling the movable platform to move to the region or location indicated by the control signal may refer to the contents describing step 1203 of the embodiment shown in FIG. 12, which are not repeated.

In some embodiments, if it is determined that the movable platform cannot broadcast information indicating relevant parameters of the movable platform, then other operations may not be executed for the movable platform, such that the movable platform may maintain the current operations. Distance from the movable platform to the flight restricted region may continue to be monitored, which is not limited by the present disclosure.

In some embodiments, if it is determined that the movable platform cannot broadcast information indicating a relevant parameter of the movable platform, and it is determined that the current height of the movable platform is greater than the predetermined height value, then the movable platform may not receive the control signal, or may receive the control signal, which is not limited by the present disclosure.

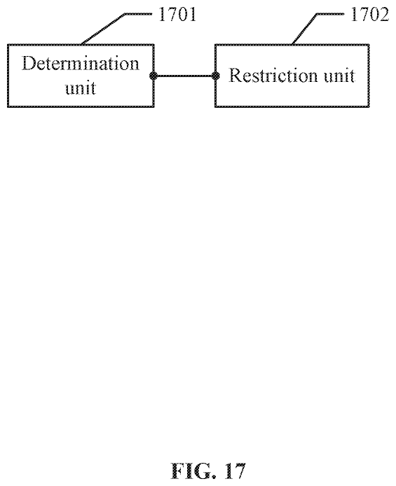

The above described various embodiments of the method for controlling the movable platform. Next, various embodiments of a movable platform will be described. Referring to FIG. 17, an embodiment of the movable platform may include:

a determination unit 1701 configured to determine whether the movable platform can broadcast information indicating a relevant parameter of the movable platform;

a restriction unit 1702 configured to restrict movement of the movable platform when it is determined that the movable platform cannot broadcast information.

In some embodiments, the determination unit 1701 may be further configured to:

determine whether a positioning device of the movable platform can operate normally, and when the positioning device cannot operate normally, determine that the movable platform cannot broadcast information.

In some embodiments, the determination unit 1701 may be further configured to:

determine whether location information output by the positioning device of the movable platform is effective, and when it is determined that the location information is ineffective, determine that the movable platform cannot broadcast information.

In some embodiments, the determination unit 1701 may be further configured to:

determine a signal-to-noise ratio of the location information, and when the signal-to-noise ratio is smaller than or equal to a predetermined signal-to-noise ratio value, determine that the location information is ineffective.

In some embodiments, the determination unit 1701 may be further configured to:

obtain a number of satellites corresponding to the location information, and when the number of satellites is smaller than or equal to a predetermined number, determine that the location information is ineffective.

In some embodiments, the determination unit 1701 may be further configured to:

determine whether an information broadcasting device of the movable platform configured to broadcast information can operate normally, and when the information broadcasting device cannot operate normally, determine that the movable platform cannot broadcast information.

In some embodiments, the determination unit 1701 may be further configured to:

determine whether a baseband processor of the information broadcasting device can operate normally, and when the baseband processor cannot operate normally, determine that the information broadcasting device cannot operate normally.

In some embodiments, the determination unit 1701 may be further configured to:

determine whether a transmitter of the information broadcasting device configured to broadcast information can operate normally, and when the transmitter cannot operate normally, determine that the information broadcasting device cannot operate normally.

In some embodiments, the restriction unit 1702 may be further configured to:

determine whether the movable platform is located in a supervision region, and when the movable platform is located in the supervision region and the movable platform cannot broadcast information, restrict movement of the movable platform.

In some embodiments, the restriction unit 1702 may be further configured to:

when the movable platform is located in the supervision region and a distance from the movable platform to a flight restricted region is smaller than or equal to a first predetermined distance value, restrict movement of the movable platform, where the supervision region at least partially includes the flight restricted region (or at least includes a part of the flight restricted region).

In some embodiments, the restriction unit 1702 may be further configured to:

determine a distance from the movable platform to the flight restricted region, and when the distance from the movable platform to the flight restricted region is smaller than or equal to the first predetermined distance value and when the movable platform cannot broadcast information, restrict the movement of the movable platform.

In some embodiments, the restriction unit 1702 may be further configured to:

determine a distance from the movable platform to the flight restricted region, and when the distance from the movable platform to the flight restricted region is smaller than or equal to the first predetermined distance value, restrict the movement of the movable platform.

In some embodiments, the restriction unit 1702 may be further configured to:

restrict one or more of a height, a moving distance, an operation time, a moving velocity, a moving acceleration, or a moving direction of the movable platform.

In some embodiments, the restriction unit 1702 may be further configured to:

obtain a current height of the movable platform, and when the current height is greater than or equal to a predetermined height value, execute a restriction strategy.

In some embodiments, the restriction unit 1702 may be further configured to:

obtain a current moving distance of the movable platform, and when the current moving distance is greater than or equal to a second predetermined distance value, execute the restriction strategy.

In some embodiments, the current moving distance may be a distance from the movable platform to a moving-start point or a control terminal of the movable platform.

In some embodiments, the current moving distance may be determined based on one or more of positioning information output by a positioning device of the movable platform, a power of a signal received by the movable platform from a control terminal of the movable platform, or a round-trip time of a signal between the movable platform and the control terminal of the movable platform.

In some embodiments, the restriction unit 1701 may be further configured to:

obtain the current moving distance of the movable platform, and when the current moving distance is smaller than or equal to a third predetermined distance value, execute the restriction strategy.

In some embodiments, the current moving distance may include a distance from the movable platform to a supervision device of the movable platform.

In some embodiments, the current moving distance may be determined based on one or more of a power of a signal transmitted by the supervision device and received by the movable platform, or a round-trip time of a signal between the movable platform and the supervision device.

In some embodiments, the current moving distance may include a distance from the movable platform to a flight restricted region.

In some embodiments, the current moving distance may be determined based on one or more of a power of a signal broadcasted by an electronic label and received by the movable platform, or a round-trip time of a signal between the movable platform and the electronic label. The electronic label may be provided at a boundary of the flight restricted region.

In some embodiments, the restriction unit 1702 may be further configured to:

obtain an operation time of the movable platform, and when the operation time is greater than or equal to a predetermined time value, execute the restriction strategy.

In some embodiments, the operation time of the movable platform may include one or more of an operation time of a propulsion system of the movable platform, a power supply time of the movable platform, or a time during which the movable platform is in a moving state.

In some embodiments, the restriction unit 1702 may be further configured to:

control the movable platform to stay at a current location.

In some embodiments, the restriction unit 1702 may be further configured to:

control the movable platform to move to a predetermined region.

In some embodiments, the predetermined region may include a legal operation region of the movable platform.

In some embodiments, the restriction unit 1702 may be further configured to:

control the movable platform to move to a predetermined location.

In some embodiments, the predetermined location may include at least one of a location where movable platform starts to move, or a location where the control terminal of the movable platform is located.

In some embodiments, the restriction unit 1702 may be further configured to:

receive a control signal transmitted by a supervision device, and control, based on the control signal, the movable platform to move to a region or a location indicated by the control signal.

In some embodiments, the restriction unit 1702 may be further configured to:

transmit restriction information to the control terminal of the movable platform, the restriction information configured to indicate that the movable platform is executing the restriction strategy.

In some embodiments, the restriction unit 1702 may be further configured to:

turn on or flash one or more indicator lamps of the movable platform based on a predetermined control scheme.

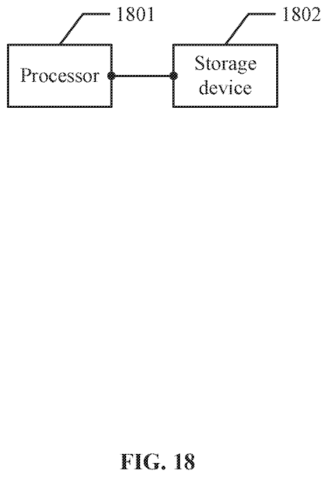

The above described the movable platform from the perspective of modularized functional entities. Next, the movable platform will be described from the hardware processing perspective. Referring to FIG. 18, another embodiment of the movable platform may include:

a processor 1801 and a storage device 1802 (the number of the processor 1801 may be one or more than one, FIG. 18 shows one processor 1801 as an example);

The storage device 1802 may be configured to store program instructions.

The processor 1801 may be configured to retrieve the program instructions stored in the storage device 1802, and to execute the program instructions to:

determine whether the movable platform can broadcast information indicating a relevant parameter of the movable platform; and

when the movable platform cannot broadcast information, restrict movement of the movable platform.

In some embodiments, the processor 1801 may be further configured to:

determine whether a positioning device of the movable platform can operate normally, and when the positioning device cannot operate normally, determine that the movable platform cannot broadcast information.

In some embodiments, the processor 1801 may be further configured to:

determine whether location information output by the positioning device of the movable platform is effective, and when the location information is ineffective, determine that the movable platform cannot broadcast information.

In some embodiments, the processor 1801 may be further configured to:

determine a signal-to-noise ratio of the location information, and when the signal-to-noise ratio is smaller than or equal to a predetermined signal-to-noise ratio value, determine that the location information is ineffective.

In some embodiments, the processor 1801 may be further configured to:

obtain a number of satellites corresponding to the location information, and when the number of satellites is smaller than or equal to a predetermined number, determine that the location information is ineffective.

In some embodiments, the processor 1801 may be further configured to:

determine whether an information broadcasting device of the movable platform configured to broadcast information can operate normally, and when the information broadcasting device cannot operate normally, determine that the movable platform cannot broadcast information.

In some embodiments, the processor 1801 may be further configured to:

determine whether a baseband processor of the information broadcasting device can operate normally, and when the baseband processor cannot operate normally, determine that the information broadcasting device cannot operate normally.

In some embodiments, the processor 1801 may be further configured to:

determine whether a transmitter of the information broadcasting device configured to broadcast information can operate normally, and when the transmitter cannot operate normally, determine that the information broadcasting device cannot operate normally.

In some embodiments, the processor 1801 may be further configured to:

determine whether the movable platform is currently located in a supervision region, and when the movable platform is located in the supervision region and the movable platform cannot broadcast information, restrict movement of the movable platform.

In some embodiments, the processor 1801 may be further configured to:

determine a distance from the movable platform to a flight restricted region, and when the movable platform is located in the supervision region and when the distance from the movable platform to the flight restricted region is smaller than or equal to a first predetermined distance value, restrict movement of the movable platform, where the supervision region at least partially include the flight restricted region.

In some embodiments, the processor 1801 may be further configured to:

determine the distance from the movable platform to the flight restricted region, and when the distance from the movable platform to the flight restricted region is smaller than or equal to the first predetermined distance value and when the movable platform cannot broadcast information, restrict the movement of the movable platform.

In some embodiments, the processor 1801 may be further configured to:

determine the distance from the movable platform to the flight restricted region, and when the distance from the movable platform to the flight restricted region is smaller than or equal to the first predetermined distance value, restrict the movement of the movable platform.

In some embodiments, the processor 1801 may be further configured to:

restrict one or more of a height, a moving distance, an operation time, a moving velocity, a moving acceleration, or a moving direction of the movable platform.

In some embodiments, the processor 1801 may be further configured to:

obtain a current height of the movable platform, and when the current height is greater than or equal to a predetermined height value, execute a restriction strategy.

In some embodiments, the processor 1801 may be further configured to:

obtain a current moving distance of the movable platform, and when the current moving distance is greater than or equal to a second predetermined distance value, execute the restriction strategy.

In some embodiments, the processor 1801 may be further configured to:

obtain the current moving distance of the movable platform, and when the current moving distance is smaller than or equal to a third predetermined distance value, execute the restriction strategy.

In some embodiments, the processor 1801 may be further configured to:

obtain a current operation time of the movable platform, and when the current operation time is greater than or equal to a predetermined time value, execute the restriction strategy.

In some embodiments, the processor 1801 may be further configured to:

control the movable platform to stay at a current location.

In some embodiments, the processor 1801 may be further configured to:

control the movable platform to move to a predetermined region.

In some embodiments, the processor 1801 may be further configured to:

control the movable platform to move to a predetermined location.

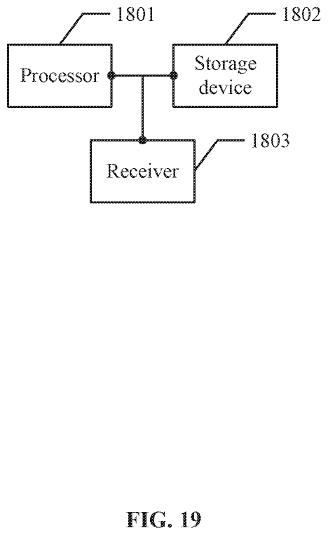

In some embodiments, as shown in FIG. 19, the movable platform may also include a receiver 1803 configured to:

receive a control signal transmitted by a supervision device.

In some embodiments, the processor 1801 may be further configured to:

control, based on the control signal, the movable platform to move to a region or a location indicated by the control signal.

In some embodiments, the processor 1801 may be further configured to:

transmit restriction information to a control terminal of the movable platform, the restriction information configured to indicate that the movable platform is executing the restriction strategy.

In some embodiments, the processor 1801 may be further configured to:

turn on or flash one or more indicator lamps of the movable platform based on a predetermined control scheme.

It is understood that in actual operations of the movable platform, the present disclosure may further provide a movable platform system, including the control terminal of the movable platform, the movable platform that communicates with the control terminal, and the supervision device configured to supervise the movable platform. The control terminal may be configured to transmit a control command to the movable platform. The movable platform may include a positioning device, an information broadcasting device, a controller, a machine body, a sensing component, and a landing gear. The controller may control the movement of the movable platform based on the received control command. The control terminal may be a remote control device of the movable platform, a tablet configured with a control system, a cell phone, a smart wearable device, etc. The supervision device may be configured to obtain communication data between the movable platform and the control terminal to realize the supervision of the movable platform. The supervision device may include a receiver and a baseband processor.

A person having ordinary skills in the art can appreciate that for convenience and simplicity of the descriptions, the detailed operations of the above-described system, device, and unit can refer to the corresponding processes of the various embodiments of the method, which are not repeated.

A person having ordinary skill in the art can appreciate that the various system, device, and method illustrated in the example embodiments may be implemented in other ways. For example, the disclosed embodiments for the device are for illustrative purpose only. Any division of the units are logic divisions. Actual implementation may use other division methods. For example, multiple units or components may be combined, or may be integrated into another system, or some features may be omitted or not executed. Further, couplings, direct couplings, or communication connections may be implemented using indirect coupling or communication between various interfaces, devices, or units. The indirect couplings or communication connections between interfaces, devices, or units may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. The actual configuration or distribution of the units or components may be selected or designed based on actual need of applications.

Various functional units or components may be integrated in a single processing unit, or may exist as separate physical units or components. In some embodiments, two or more units or components may be integrated in a single unit or component. The integrated unit may be realized using hardware or a combination of hardware and software.

If the integrated units are realized as software functional units and sold or used as independent products, the integrated units may be stored in a computer-readable storage medium. Based on such understanding, the portion of the technical solution of the present disclosure that contributes to the current technology, or some or all of the disclosed technical solution may be implemented as a software product. The computer software product may be storage in a non-transitory storage medium, including instructions or codes for causing a computing device (e.g., personal computer, server, or network device, etc.) to execute some or all of the steps of the disclosed methods. The storage medium may include any suitable medium that can store program codes or instruction, such as at least one of a U disk (e.g., flash memory disk), a mobile hard disk, a read-only memory (“ROM”), a random access memory (“RAM”), a magnetic disk, or an optical disc.

The above embodiments are only examples of the present disclosure, and do not limit the scope of the present disclosure. Although the technical solutions of the present disclosure are explained with reference to the above-described various embodiments, a person having ordinary skills in the art can understand that the various embodiments of the technical solutions may be modified, or some or all of the technical features of the various embodiments may be equivalently replaced. Such modifications or replacement do not render the spirit of the technical solutions falling out of the scope of the various embodiments of the technical solutions of the present disclosure.

What is claimed is:

1. A method for controlling a movable platform, comprising:
determining whether the movable platform is capable of broadcasting information indicating a relevant parameter of the movable platform; and
restricting a movement of the movable platform based on a determination that the movable platform is not capable of broadcasting the information.

2. The method of claim 1, wherein the relevant parameter comprises at least location information of the movable platform.

3. The method of claim 2, wherein determining whether the movable platform is capable of broadcasting the information indicating the relevant parameter of the movable platform comprises:
determining whether a positioning device is capable of operating normally; and
determining that the movable platform is not capable of broadcasting the information based on a determination that the positioning device is not capable of operating normally.

4. The method of claim 2, wherein determining whether the movable platform is capable of broadcasting the information indicating the relevant parameter of the movable platform comprises:
determining whether the location information output by a positioning device of the movable platform is effective; and
determining that the movable platform is not capable of broadcasting the information based on a determination that the location information is ineffective.

5. The method of claim 4, wherein determining whether the location information output by the positioning device of the movable platform is effective comprises:
determining a signal-to-noise ratio of the location information; and
determining that the location information is ineffective when the signal-to-noise ratio is smaller than or equal to a predetermined signal-to-noise ratio value.

6. The method of claim 4, wherein determining whether the location information output by the positioning device of the movable platform is effective comprises:
obtaining a number of satellites corresponding to the location information; and
determining that the location information is ineffective when the number of satellites is smaller than or equal to a predetermined value.

7. The method of claim 1, wherein determining whether the movable platform is capable of broadcasting the information indicating the relevant parameter of the movable platform comprises:
determining whether an information broadcasting device of the movable platform configured to broadcast the information is capable of operating normally; and
determining that the movable platform is not capable of broadcasting the information based on a determination that the information broadcasting device is not capable of operating normally.

8. The method of claim 7, wherein determining whether the information broadcasting device of the movable platform configured to broadcast the information is capable of operating normally comprises:
determining whether a baseband processor of the information broadcasting device is capable of operating normally; and
determining that the information broadcasting device is not capable of operating normally based on a determination that the baseband processor is not capable of operating normally.

9. The method of claim 7, wherein determining whether the information broadcasting device of the movable platform configured to broadcast the information is capable of operating normally comprises:
determining whether a transmitter of the information broadcasting device configured to broadcast the information is capable of operating normally; and
determining that the information broadcasting device is not capable of operating normally based on a determination that the transmitter is not capable of operating normally.

10. The method of claim 1, wherein restricting the movement of the movable platform based on a determination that the movable platform is not capable of broadcasting the information comprises:
determining whether the movable platform is located in a supervision region; and
restricting the movement of the movable platform based on a determination that the movable platform is located in the supervision region and that the movable platform is not capable of broadcasting the information.

11. The method of claim 10, further comprising:
determining a distance from the movable platform to a flight restricted region; and
restricting the movement of the movable platform based on a determination that the movable platform is located in the supervision region and that the distance from the movable platform to the flight restricted region is smaller than or equal to a first predetermined distance value,
wherein the supervision region at least partially includes the flight restricted region.

12. The method of claim 1, wherein restricting the movement of the movable platform based on a determination that the movable platform is not capable of broadcasting the information comprises:
determining a distance from the movable platform to a flight restricted region; and
restricting the movement of the movable platform based on a determination that the distance from the movable platform to the flight restricted region is smaller than or equal to a first predetermined distance value and that the movable platform is not capable of broadcasting the information.

13. The method of claim 1, further comprising:
determining a distance from the movable platform to a flight restricted region; and
restricting the movement of the movable platform based on a determination that the distance from the movable platform to the flight restricted region is smaller than or equal to a first predetermined distance value.

14. The method of claim 1, wherein restricting the movement of the movable platform comprises:
restricting one or more of a height, a moving distance, an operation time, a moving velocity, a moving acceleration, or a moving direction of the movable platform.

15. The method of claim 1, wherein restricting the movement of the movable platform comprises:
obtaining a current height of the movable platform; and
executing a restriction strategy when the current height is greater than or equal to a predetermined height value.

16. The method of claim 1, wherein restricting the movement of the movable platform comprises:
obtaining a current moving distance of the movable platform; and
executing a restriction strategy when the current moving distance is greater than or equal to a second predetermined distance value.

17. The method of claim 16, wherein the current moving distance is a distance from the movable platform to a moving-start point or to a control terminal of the movable platform.

18. The method of claim 17, wherein the current moving distance is determined based on one or more of location information of a positioning device of the movable platform, a power of a signal received by the movable platform from a control terminal of the movable platform, or a round-trip time of a signal between the movable platform and the control terminal of the movable platform.

19. The method of claim 1, wherein restricting the movement of the movable platform comprises:
obtaining a current moving distance of the movable platform; and
executing a restriction strategy based on a determination that the current moving distance is smaller than or equal to a third predetermined distance value.

20. The method of claim 19, wherein the current moving distance includes a distance from the movable platform to a supervision device of the movable platform.

21. The method of claim 20, wherein the current moving distance is determined based on one or more of a power of a signal received by the movable platform that is transmitted by the supervision device, or a round-trip time of a signal between the movable platform and the supervision device.

22. The method of claim 19, wherein the current moving distance comprises a distance from the movable platform to a flight restricted region.

23. The method of claim 22,
wherein the current moving distance is determined based on one or more of a power of a signal received by the movable platform that is broadcasted by an electronic label, or a round-trip time of a signal between the movable platform and the electronic label, and
wherein the electronic label is provided at a boundary of the flight restricted region.

24. The method of claim 1, wherein restricting the movement of the movable platform comprises:
obtaining a current operation time of the movable platform; and
executing a restriction strategy based on a determination that the current operation time is greater than or equal to a predetermined time value.

25. The method of claim 24, wherein the current operation time of the movable platform comprises one or more of an operation time of a propulsion system of the movable platform, a power supply time of the movable platform, or a time during which the movable platform is in a moving state.

26. The method of claim 15, wherein executing the restriction strategy comprises at least one of:
controlling the movable platform to stay at a current location;
controlling the movable platform to move to a predetermined region, wherein the predetermined region comprises a legal operation region of the movable platform;
controlling the movable platform to move to a predetermined location; or
receiving a control signal transmitted by a supervision device and controlling the movable platform to move to a region or location indicated by the control signal.

27. The method of claim 26, wherein the predetermined location comprises at least one of a start-moving location of the movable platform, or a location of a control terminal of the movable platform.

28. The method of claim 26, wherein executing the restriction strategy further comprises:
transmitting restriction information to a control terminal of the movable platform, the restriction information being configured to indicate that the movable platform is executing the restriction strategy.

29. The method of claim 26, wherein executing the restriction strategy further comprises:
turning on or flashing one or more indicator lamps of the movable platform based on a predetermined control scheme.
